(19) United States
(12) Patent Application Publication
(10) Pub. No.: US 2026/0303526 A1
(43) Pub. Date: Oct. 1, 2026

(54) NETWORK IP PROJECTION AND INTEGRATION SYSTEM, METHOD, AND PRODUCT

(71) Applicant: noBGP, Inc., Palo Alto, CA (US)

(72) Inventors: Michael W. Johnson, Petaluma, CA (US); Benoit Menendez, Penngrove, CA (US); Ryo Koyama, Palo Alto, CA (US); Jamie Ruderman, Santa Rosa, CA (US); Steve Avery, Portland, OR (US); Davin Oishi, Vancouver (CA); Rob McDonald, Van Alstyne, TX (US)

(21) Appl. No.: 19/630,147

(22) Filed: Mar. 26, 2026

Related U.S. Application Data
(60) Provisional application No. 63/781,202, filed on Mar. 31, 2025.

(51) Int. Cl. H04L 45/741; H04L 9/32; H04L 41/0663; H04L 45/745

(52) U.S. Cl. CPC H04L 45/741; H04L 9/3213; H04L 41/0663; H04L 45/745

(57) ABSTRACT

A system, method, and computer program are provided for translating and routing internet protocol (IP) packets between an IP address on one network and an IP address on a different network. To this end, source network hosts are unaware that they are not communicating with a local host, as the foreign host is seamlessly integrated into the local network, appearing as if it were a local entity, thus projecting one IP address on a network to another IP address on a different network.

### RELATED APPLICATIONS

The present application claims priority to U.S. Provisional Application No. 63/781,202 (Attorney Docket No. Application No. NOBGP001+), entitled “NETWORK IP PROJECTION AND INTEGRATION SYSTEM, METHOD, AND PRODUCT,” and filed Mar. 31, 2025, the entire contents of which is incorporated herein by reference.

### FIELD OF THE INVENTION

The present invention relates to computer networks.

### BACKGROUND

Computer networks are generally formed by a plurality of devices that are wired and/or wirelessly connected to enable communications with one another. Networked computing devices typically include, but are not limited to, cloud-based servers, virtual machines, containerized environments, physical servers, desktop computers, laptops, embedded systems, Internet of Things (IOT) devices, and edge computing nodes. Furthermore, computer networks can also encompass various network devices such as routers, switches, gateways, firewalls, and load balancers. These network often extend to both mobile and non-mobile devices across enterprise, industrial, and consumer settings.

Many protocols exist to control the communication methods used by computer networks. However, these existing protocols are limited, particularly with regard to communications between networks. For example, existing protocols often require networked computing devices and/or other network devices to have specialized software installed thereon, configuration changes, routing modifications, etc.

There is thus a need for addressing these and/or other issues associated with the prior art.

### SUMMARY

As described herein, a system, method, and computer program are provided for translating and routing internet protocol (IP) packets between an IP address on one network and an IP address on a different network. To this end, source network hosts are unaware that they are not communicating with a local host, as the foreign host is seamlessly integrated into the local network, appearing as if it were a local entity, thus projecting one IP address on a network to another IP address on a different network.

### BRIEF DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 shows a method for translating and routing IP packets between an IP address on one network and an IP address on a different network, in accordance with one embodiment.

FIG. 4 shows a method of interconnecting the system in FIG. 3, in accordance with one embodiment.

FIG. 5 illustrates a stack of components used to capture, inject, process and transport network packets, in accordance with one embodiment.

FIG. 6 illustrates a system with multiple routers handling multiple paths between endpoints, in accordance with one embodiment.

FIG. 7 illustrates an Address Resolution Protocol (ARP) handling flow, in accordance with one embodiment.

FIG. 8 illustrates an Internet Control Message Protocol (ICMP) echo request/reply handling flow, in accordance with one embodiment.

FIGS. 9A-B illustrate a session establishment and key exchange flow, in accordance with one embodiment.

FIGS. 10-12 illustrate exemplary user interface (UI) configuration screens, in accordance various embodiments.

FIG. 13 illustrates a proxy flowchart, in accordance with one embodiment.

FIG. 14 illustrates a gateway flowchart, in accordance with one embodiment.

FIG. 15 illustrates a router flowchart, in accordance with one embodiment.

FIG. 16 illustrates a system overview, in accordance with one embodiment.

FIG. 17 illustrates an outbound packet flow stack, in accordance with one embodiment.

FIG. 18 illustrates an inbound packet flow stack, in accordance with one embodiment.

FIG. 19 illustrates a Docker-to-Docker packet flow diagram, in accordance with one embodiment.

FIG. 20 illustrates a proxy-router-gateway packet trace, in accordance with one embodiment.

FIG. 21 illustrates a session establishment sequence diagram, in accordance with one embodiment.

### DETAILED DESCRIPTION

Embodiments described herein relate to translating and routing IP packets between an IP address on one network and an IP address on a different network. These embodiments may be referred to as “Mobeus” with “M-” used in diagrams to identify a Mobeus component.

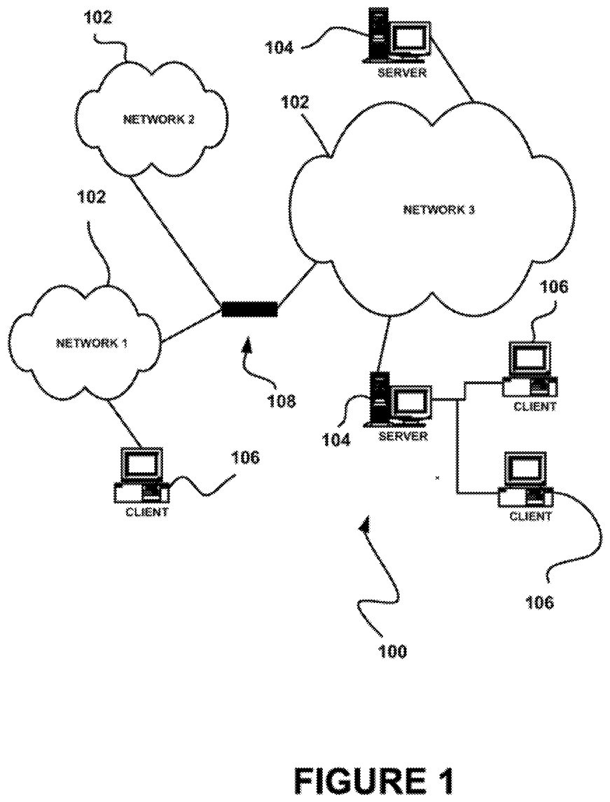

FIG. 1 illustrates a network architecture 100, in accordance with one embodiment. As shown, a plurality of networks 102 is provided. In the context of the present network architecture 100, the networks 102 may each take any form, including but not limited to a local area network (LAN), a wireless network, a wide area network (WAN) such as the Internet, peer-to-peer network, etc.

Coupled to the networks 102 are servers 104 which are capable of communicating over the networks 102. Also coupled to the networks 102 and the servers 104 is a plurality of clients 106. Such servers 104 and/or clients 106 may each include a desktop computer, laptop computer, hand-held computer, mobile phone, personal digital assistant (PDA), tablet computer, peripheral (e.g., printer, etc.), any component of a computer, and/or any other type of logic. In order to facilitate communication among the networks 102, at least one gateway 108 is optionally coupled there between.

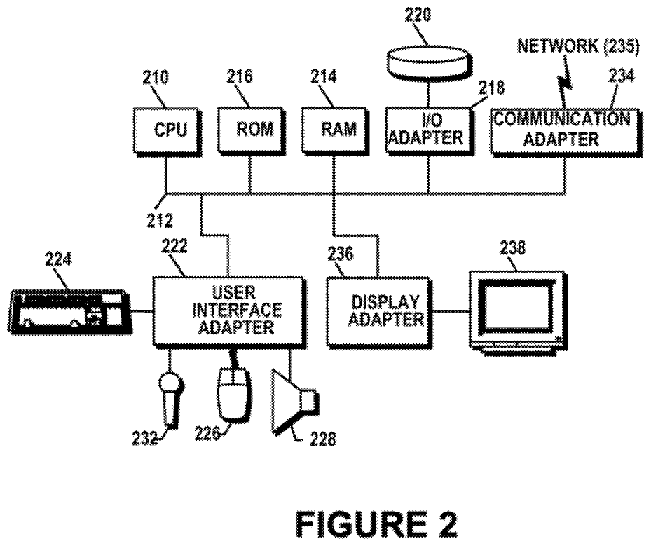

FIG. 2 shows a representative hardware environment that may be associated with the servers 104 and/or clients 106 of FIG. 1, in accordance with one embodiment. Such figure illustrates a typical hardware configuration of a mobile device in accordance with one embodiment having a central processing unit 210, such as a microprocessor, and a number of other units interconnected via a system bus 212.

The mobile device shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the mobile device to a communication network 235 (e.g., a data processing network) and a display adapter 236 for connecting the bus 212 to a display device 238.

Of course, the various embodiments set forth herein may be implemented utilizing hardware, software, or any desired combination thereof. For that matter, any type of logic may be utilized which is capable of implementing the various functionality set forth herein.

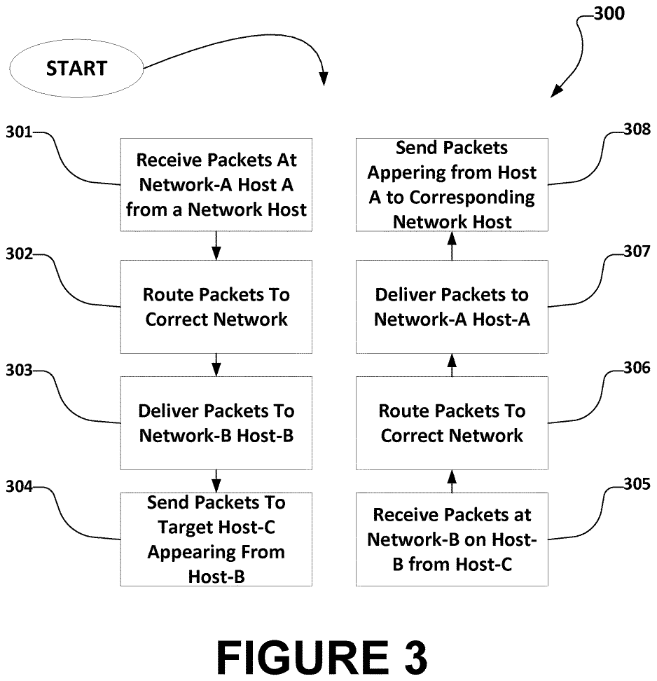

FIG. 3 shows a method 300 for translating and routing IP packets between an IP address on one network and an IP address on a different network, in accordance with one embodiment. As an option, the method may be implemented in the context of the architecture and environment of any subsequent Figure(s). Of course, however, the method may be implemented in any desired environment.

As shown in operation 301, a packet is received on a network host. In one embodiment, the packet will be identified. In the context of the present description, such identification may include Source MAC Address, Destination MAC Address, MAC EtherType/Length Field, VLAN Tag, ARP HTYPE, ARP PTYPE, ARP HLEN, ARP PLEN, ARP Operation, ARP SHA, ARP SPA, ARP THA, ARP TPA, IP Version, IP Header Length (IHL), IP Type of Service (ToS), IP Total Length, IP Identification, IP Flags, IP Fragment Offset, IP Time to Live (TTL), IP Protocol, IP Header Checksum, IP Source Address, IP Destination Address, IP Options, ICMP Type, ICMP Code, ICMP Checksum, ICMP Rest of Header, TCP Source Port, TCP Destination Port, TCP Sequence Number, TCP Acknowledgment Number, TCP Data Offset, TCP Reserved, TCP Flags, TCP Window Size, TCP Checksum, TCP Urgent Pointer, TCP Options, UDP Source Port, UDP Destination Port, UDP Length, and UDP Checksum.

In one embodiment, an identified packet may be captured based on an identified characteristic listed above.

In one embodiment, an identified packet may be filtered based on an identified characteristic listed above.

In one embodiment, an identified packet may be left unchanged.

In other embodiments, identification characteristics may be remembered for later used.

In other embodiments, identification characteristics may be stored for later used.

In other embodiments, signals outside packet identification may alter actions taken or not taken on a packet.

As shown in operation 302, a packet is routed to the correct network. In one embodiment, the packet will be identified packet from operation 301. In the context of the present description the packet will be routed based on a computed route value or lack thereof.

In one embodiment, the route is based previously stored association.

In one embodiment, the route is based on a shared key.

In other embodiments, the route may be based on a preconfigured route table.

In other embodiments, the route may be based on a dynamic route table.

In other embodiments, the route may be based on characteristic described above.

In other embodiments, the route may be based on geolocation.

In other embodiments, the route may be based external signals.

In other embodiments, the route may be based on management packets.

In other embodiments, the route may be based network load.

In other embodiments, the route may be based network latency.

In other embodiments, the route may be based on MPLS labels.

In other embodiments the route may be based on Segment Routing (SR) over IPV6 (SRv6) or MPLS (SR-MPLS).

In other embodiments, the route may be based on Software-Defined Networking (SDN).

In other embodiments, the route may be based on Ethernet Virtual Private Network (EVPN).

As shown in operation 303, a packet is delivered to the correct host on the correct network. In one embodiment, the host in operation 303 may accept delivery of the packet via a router or other network delivery method. In the context of the present description the router and host may have an established connection in which packets may be routed as a deliver method.

In one embodiment, the original packet may be stripped of any identifying information IE MAC Header, IP Header and/or transport layer information (UDP and/or TCP) as to not identify the origin.

In other embodiments, Meta data may be sent to identify packets in lieu of identifying information stripped, as described above.

In other embodiments, identifying information sent for later filtering.

In other embodiments, identifying information sent for later logging.

In one embodiment, the delivery method may be a TCP socket.

In other embodiments, the deliver method is a Websocket connection.

In other embodiments, the deliver method may be a UDP socket.

In other embodiments, the deliver method may be a QUIC (Quick UDP Internet Connections) connection.

In other embodiments, the deliver method may MPLS (Multiprotocol Label Switching).

Also in the context of the present description, the aforementioned delivery method may or may not be combined encryption and/or authentication of packets, control information, out of band data, in band data any device including, but not limited to those described in the context of this and/or subsequently described embodiments.

As shown in operation 304, a packet is sent to the target host (Host C) on the local network appearing to be from the sending host (Host B). The packet is modified so that Host C perceives the packet as originating from Host B rather than the remote host.

In one embodiment, the Host B rewrites the source IP address and, optionally, the source port of the packet to its own address before forwarding it to Host C. As a result, Host C interacts with Host B as if it were the true source of the packet, concealing the identity of the original source of the original packet.

In one embodiment, the Host B rewrites the source IP address and, optionally, the source port of the packet to a virtual IP address before forwarding it to Host C. As a result, Host C interacts with the Virtual IP address as if it were the true source of the packet, concealing the identity of the original source of the original packet.

In other embodiments, Host B may emulate or spoof one or more Virtual IP addresses to be used as a source of packets.

In one embodiment, the Mobeus-Proxy component performs Address Resolution Protocol (ARP) handling to enable the projection of a remote IP address onto the local network. When the Mobeus-Proxy is configured to project a target IP address onto the local network, the Mobeus-Proxy monitors the network interface for ARP Request packets whose Target Protocol Address (TPA) matches the projected IP address. Upon detecting such an ARP Request, the Mobeus-Proxy generates an ARP Reply packet containing: the projected IP address as the Sender Protocol Address (SPA), the Mobeus-Proxy's own MAC address as the Sender Hardware Address (SHA), the requesting host's IP address as the Target Protocol Address (TPA), and the requesting host's MAC address as the Target Hardware Address (THA). The Mobeus-Proxy transmits this ARP Reply onto the local network, causing the requesting host to associate the projected IP address with the Mobeus-Proxy's MAC address in its ARP cache.

In another embodiment, the Mobeus-Proxy may proactively send Gratuitous ARP (GARP) announcements upon startup or upon configuration changes. A Gratuitous ARP is an ARP packet where both the Sender and Target Protocol Addresses are set to the projected IP address, and the Sender Hardware Address is set to the Mobeus-Proxy's MAC address. Broadcasting a Gratuitous ARP causes all hosts on the local network segment to update their ARP caches, associating the projected IP address with the Mobeus-Proxy's MAC address without requiring each host to individually issue an ARP Request. This reduces initial latency when local hosts first attempt to communicate with the projected IP address.

In another embodiment, the Mobeus-Proxy may maintain a local ARP table that tracks which local hosts have resolved the projected IP address. This table may be used for diagnostic purposes, for determining which local hosts are actively communicating with the projected IP address, or for selectively responding to ARP requests from specific hosts while ignoring others, thereby implementing host-level access control at the ARP layer.

In another embodiment, the Mobeus-Proxy may project multiple IP addresses simultaneously, maintaining an ARP response table for each projected IP address. Each projected IP address corresponds to a different remote target host accessible through a different or the same Mobeus-Gateway. The Mobeus-Proxy responds to ARP requests for each projected IP address with its own MAC address, and uses the destination IP address of incoming packets to determine which Mobeus-Gateway connection should receive the translated packet.

In one embodiment, the Mobeus-Gateway component also performs ARP handling on the target network. When the Mobeus-Gateway receives a translated packet from the router and prepares to forward it to the target host, the Mobeus-Gateway first resolves the target host's MAC address by issuing an ARP Request for the target IP address on the local network, or by consulting a cached ARP entry. The resolved MAC address is used to construct the Ethernet header of the injected packet. The Mobeus-Gateway may maintain a persistent ARP cache for the target host to avoid repeated ARP resolution for subsequent packets in the same flow.

In another embodiment, the Mobeus-Proxy may detect and handle ARP conflicts. If another device on the local network claims the projected IP address via an ARP announcement, the Mobeus-Proxy may reassert ownership by broadcasting a Gratuitous ARP with its own MAC address, log the conflict for administrative review, or cease projection of the conflicting IP address and report an error to the management system.

In other embodiments, Host B may emulate or spoof a gateway or a route to be a better path for one or more IP addresses.

In other embodiments, Host B may use the packet modification information to identify future receive packets are related to a connection.

As shown in operation 305, a packet is received from the target host (Host C) by Host B. In one embodiment, the packet will be identified. In the context of the present description, such identification may include Source MAC Address, Destination MAC Address, MAC EtherType/Length Field, VLAN Tag, ARP HTYPE, ARP PTYPE, ARP HLEN, ARP PLEN, ARP Operation, ARP SHA, ARP SPA, ARP THA, ARP TPA, IP Version, IP Header Length (IHL), IP Type of Service (ToS), IP Total Length, IP Identification, IP Flags, IP Fragment Offset, IP Time to Live (TTL), IP Protocol, IP Header Checksum, IP Source Address, IP Destination Address, IP Options, ICMP Type, ICMP Code, ICMP Checksum, ICMP Rest of Header, TCP Source Port, TCP Destination Port, TCP Sequence Number, TCP Acknowledgment Number, TCP Data Offset, TCP Reserved, TCP Flags, TCP Window Size, TCP Checksum, TCP Urgent Pointer, TCP Options, UDP Source Port, UDP Destination Port, UDP Length, and UDP Checksum.

In one embodiment, an identified packet may be captured based on an identified characteristic listed above.

In one embodiment, an identified packet may be dropped based on an identified characteristic listed above.

In one embodiment, an identified packet may be filtered based on an identified characteristic listed above.

In one embodiment, an identified packet may be forwarded based on an identified characteristic listed above.

In one embodiment, an identified packet may be checked against information stored, as described above, to identify a related packet to further process.

In one embodiment, an identified packet may be left unchanged and may be passed to the host system.

As shown in operation 306, a packet is routed back to the correct network. In one embodiment, the packet will be identified packet from operation 305. In the context of the present description the packet will be routed based on a computed route value or lack thereof.

In one embodiment, the route is based previously stored association, as described above.

In one embodiment, the route is based on a shared key.

In other embodiments, the route may be based on a preconfigured route table.

In other embodiments, the route may be based on a dynamic route table.

In other embodiments, the route may be based on a characteristic described above.

In other embodiments, the route may be based on geolocation.

In other embodiments, the route may be based external signals.

In other embodiments, the route may be based on management packets.

In other embodiments, the route may be based network load.

In other embodiments, the route may be based network latency.

In other embodiments, the route may be based on MPLS labels.

In other embodiments, the route may be based on Segment Routing (SR) over IPV6 (SRv6) or MPLS (SR-MPLS).

In other embodiments, the route may be based on Software-Defined Networking (SDN).

In other embodiments, the route may be based on Ethernet Virtual Private Network.

In other embodiments local network appearing to be from the sending host (Host B). The packet is modified so that Host C perceives the packet as originating from Host B rather than the remote host.

As shown in operation 307, a packet is delivered to the correct host on the correct network. In one embodiment, the host in operation 307 may accept delivery of the packet via a router or other network delivery method. In the context of the present description, the router and host may have an established connection in which packets may be routed as a deliver method.

In one embodiment, the original packet may be stripped of any identifying information IE MAC Header, IP Header and/or transport layer information (UDP and/or TCP) as to not identify the origin, and may or may not include meta data to help route the packet.

In other embodiments, Meta data may be sent to identify packets in lieu of identifying information stripped as described above.

In other embodiments, identifying information sent for later filtering.

In other embodiments, identifying information sent for later logging.

In one embodiment, the delivery method may be a TCP socket.

In other embodiments, the delivery method is a Websocket connection.

In other embodiments, the delivery method may be a UDP socket.

In other embodiments, the delivery method may be a QUIC (Quick UDP Internet Connections) connection.

In other embodiments, the delivery method may MPLS (Multiprotocol Label Switching).

Also in the context of the present description, the aforementioned deliver method may or may not be combined encryption and/or authentication of packets, control information, out of band data, in band data any device including, but not limited to those described in the context of this and/or subsequently described embodiments.

As shown in operation 308, a packet is sent to an associated target host on the local network appearing to be from the sending host (Host A). The packet is modified so that the target host perceives the packet as originating from Host A rather than the host that created the packet.

In one embodiment, the Host A rewrite the destination IP, Destination port, the source IP address and, optionally, the source port of information previously stored as described above. As a result, target host interacts with Host A if it were the true source of the packet, concealing the identity of the original source of the original packet.

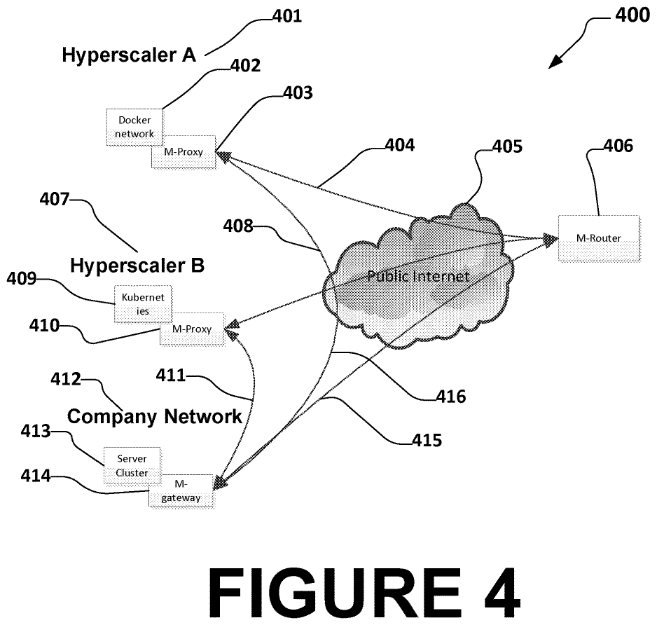

FIG. 4 shows a method of interconnecting the system in FIG. 3, in accordance with one embodiment. As an option, the method may be implemented in the context of the architecture and environment of any previous and/or subsequent Figure(s). Of course, however, the method may be implemented in any desired environment.

Coupled to the internet (public network) 405 are Hyperscaler networks 401,407 and Company network 412 which are capable of communicating to the internet 405 and the plurality of internet accessible devices/servers/resources.

### -Router

In one embodiment, one of the reachable internet resources is a Mobeus-Router 406.

In other embodiments, Mobeus-Router 406 may be accessible via private networks.

In other embodiments, Mobeus-Router 406 may be accessible only via private networks.

In other embodiments, Mobeus-Router 406 may be accessible via a load balancer.

In other embodiments, Mobeus-Router 406 may be accessible via a reverse proxy.

In other embodiments, Mobeus-Router 406 may be accessible via a VPN.

In other embodiments, the Mobeus-Router 406 may be reachable on the internet 405.

In other embodiments, the Mobeus-Router may be on any network 102 and may be on any server 104 or client 106.

In other embodiments, the Mobeus-Router may be connected via an IPV4 address, an IPv6 address or both addresses at the same time.

In other embodiments, the Mobeus-Router may be connected via multiple IPV4 address, or multiple IPv6 address or multiple IPv4 and IPv6 addresses at the same time.

In one embodiments, the Mobeus-Router 406 may be a virtual machine and/or running on a virtual machine in a virtual private cloud.

In other embodiments, the Mobeus-Router 406 may be a server or running on a server on a private network.

In other embodiments, the Mobeus-Router 406 may be reachable on the internet 405.

In other embodiments, the Mobeus-Router may be on any network 102 and may be on any server 104 or client 106.

In other embodiments, the Mobeus-Router may be connected via an IPV4 address, an IPv6 address or both addresses at the same time.

In other embodiments, the Mobeus-Router may be connected via multiple IPV4 address, or multiple IPv6 address or multiple IPv4 and IPv6 addresses at the same time.

### -Proxy

As shown in 402, a Docker network may have a Mobeus-Proxy 403 running inside docker container inside Hyperscaler Network A in one embodiment.

In other embodiments, as shown in 410 a Mobeus-Proxy may be running inside a Kubernetes cluster 409 inside Hyperscaler Network B 407.

In other embodiments, a Mobeus-Proxy may be running on any server 104 or client 106.

In other embodiments, a Mobeus-Proxy may be running on a virtual machine.

In other embodiments, a Mobeus-Proxy may be running on an internet appliance.

In other embodiments, a Mobeus-Proxy may be running on an internet appliance.

In other embodiments, a Mobeus-Proxy may be accessible via a load balancer.

In other embodiments, a Mobeus-Proxy may be accessible via public internet 405.

In other embodiments, a Mobeus-Proxy may be accessible only on a private network.

In other embodiments, a Mobeus-Proxy may be accessible only in a containerized network.

In other embodiments, a Mobeus-Proxy may be accessible only a hosts localhost network.

In other embodiments, a Mobeus-Proxy may be accessible via IPv4 address, an IPv6 address or both address types at the same time.

### -Gateway

As shown in 414, a Mobeus-Gateway 414 could be running inside a company network 412 in one embodiment.

In other embodiments, a Mobeus-Gateway. May be running in a Cloud Environment like AWS, Google Cloud, Azure.

In other embodiments, a Mobeus-Gateway. May be running in a personal network.

In other embodiments, a Mobeus-Gateway. May be running in a cellular network.

In other embodiments, a Mobeus-Gateway may be running on any server 104 or client 106.

In other embodiments, a Mobeus-Gateway may be running on a virtual machine.

In other embodiments, a Mobeus-Gateway may be running in a Docker or other container.

In other embodiments, a Mobeus-Gateway may be running on an IOT device, router or other internet appliance.

In other embodiments, a Mobeus-Gateway may be running on a mobile phone or other cellular connected devices.

In other embodiments, a Mobeus-Gateway may be running on an internet appliance.

As shown in 414, a Mobeus-Gateway could be targeting a server in a server cluster 413.

In other embodiments, a Mobeus-Gateway may target a standalone server.

In other embodiments, a Mobeus-Gateway may target the host that it is running on.

In other embodiments, a Mobeus-Gateway may target the localhost address.

In other embodiments, a Mobeus-Gateway may target a load balancer.

In other embodiments, a Mobeus-Gateway may target a public internet IP address.

In other embodiments, a Mobeus-Gateway may target a private IP address in a VPC.

In other embodiments, a Mobeus-Gateway may target an IP address in a Docker or other containerized network.

In other embodiments, a Mobeus-Gateway may target an IOT device, router or other internet appliance.

In other embodiments, a Mobeus-Gateway may target a mobile phone or other cellular connected devices.

In other embodiments, a Mobeus-Gateway may target an IPv4 address, an IPv6 address or both address types at the same time.

As shown in 415 a Mobeus-Proxy 403 and a Mobeus-Gateway 414 connect via a Mobeus-Router 406. In other embodiments a Mobeus-Proxy may connect directly to a Mobeus-Gateway and may bypass a Mobeus-Router for some or all of its traffic.

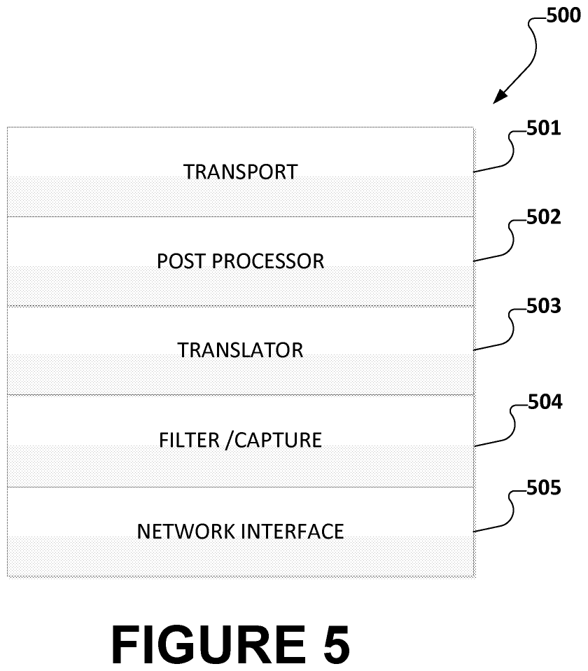

FIG. 5 illustrates a stack of components used to capture, inject, process and transport network packets. The stack of components may be referred to as a Mobeus-Proxy and/or Mobeus-Gateway stack 500, in one embodiment. This stack may be bidirectional, taking packets from the transport 501 and processing them down through 502, 503, 504 and finally out 505 and out the network interface. And likewise ingesting packets from 505 and processing them up through 504, 503, 502 and finally out the transport 501.

Network Interface 505 can send and/or receive packets on a network. When receiving packets, Filter/Capture System 504 processes them and may capture, modify, and/or filter desired packets in one embodiment.

The Filter/Capture System 504 may take action on the network interface packet ring buffer in one embodiment.

The Filter/Capture System 504 may process network packets using eBPF (Extended Berkeley Packet Filter) before they reach the system's TCP stack in one embodiment.

The Filter/Capture System 504 may intercept and process packets before eBPF using the PCAP (Packet Capture) interface in one embodiment.

The Filter/Capture System 504 may take action on network packets using the /dev/bpf0 interface in one embodiment.

When the Capture/Filter system 504 takes action on a packet it may modify the packet in place or make a copy of the packet, or remove the packet completely from the system or data path. It may also make a copy and remove it from the data path or make a copy and modify the packet in the data path. The determination of which action depends on the embodiment, configuration, and/or dynamic state of other components.

The Filter/Capture system 504 may also compile statistics not limited to number of packets modified, types of modifications, number of packets filtered, number of packet processed, number of packets copied, number of packets passed unmodified, a count of any number of attributes of the packets.

In another embodiment, the Filter/Capture system 504 may tag metadata for packets that have been modified, forwarded, copied, or dropped. This metadata can be based on any packet attribute or any classification the system determines the packet belongs to or does not belong to. The metadata may be transmitted along with the packet or sent via a separate data or signal path within the system, as illustrated in FIG. 5 and in other embodiments, to any subsystem shown in FIG. 2.

Translator 503 may process packets captured by the Filter/Capture engine and perform packet translation. In one embodiment, this translation may be a one-to-one Network Address Translation (NAT).

In another embodiment, translator 503 may remove locally identifying information from packets, relying solely on a translation ID to track packets or related packet sequences.

In another embodiment, translator 503 may identify packets using a unique packet hash. This hash may be generated from specific fields within the packet header, payload, or a combination of both. The hash can serve as a unique fingerprint, allowing tracking of individual packets without relying on traditional identifiers such as IP addresses.

In one embodiment, the translator 503 system may use flow-based tracking, where packets are identified by a combination of attributes, including source IP, destination IP, source port, destination port, and protocol (5-tuple). This allows efficient monitoring and classification of packet streams.

Translator 503 in another embodiment may also support Deep Packet Inspection (DPI), where packet payloads are analyzed to extract application-layer metadata such as HTTP headers, TLS Server Name Indication (SNI), or DNS queries. This identification method enables content-aware routing and filtering.

In another embodiment, translator 503 MAC address-based tracking may be employed for identifying packets at Layer 2, particularly within local network environments. This method may be useful for scenarios where IP addresses may change frequently, such as in dynamic or virtualized network environments.

In certain deployments, packets may be tagged using Multiprotocol Label Switching (MPLS) labels. These labels allow efficient forwarding and routing decisions without requiring deep inspection of packet headers. The translator 503 system may use these labels for network traffic engineering and prioritization.

In another embodiment, VLAN tagging may be used to distinguish between packets belonging to different logical network segments. VLAN tags can be leveraged to enforce security policies, segment traffic, or optimize network performance. The translator 503 may leverage VLAN tagging for identification, translation and meta data.

The translator 503 system may also utilize In-band Network Telemetry (INT) tags, where packets are embedded with additional metadata for real-time monitoring and analysis. These tags provide insights into packet traversal paths, network performance, and latency characteristics.

In one embodiment, Post Processing System 502 may perform encryption and decryption as part of the post-processing stage. Packets may be encrypted to ensure confidentiality before transmission or decrypted for inspection, logging, or further processing. Post Processing System 502 may also verify cryptographic signatures, ensuring that only authorized and untampered packets are processed.

In another embodiment, Post Processing System 502 may conduct packet integrity verification by validating checksums, cryptographic hashes, or other integrity markers. This ensures that packets have not been altered in transit. Corrupted or tampered packets may be flagged, logged, or discarded based on policy rules enforced by Post Processing System 502.

Post Processing System 502 may support policy-based routing decisions, where packets are analyzed post-processing to determine optimal forwarding paths. These decisions may be based on attributes such as source, destination, protocol type, QOS requirements, or security policies. Post Processing System 502 may also reroute specific traffic to designated security appliances, monitoring systems, or priority queues.

In another embodiment, Post Processing System 502 may perform traffic classification and generate metadata based on observed packet attributes. This classification may involve identifying application-layer protocols, detecting tunneling, or categorizing traffic by source and destination. The generated metadata may be stored locally, transmitted to external monitoring systems, or used for network optimization by Post Processing System 502.

Post Processing System 502 may also incorporate packet logging, where packet headers, payloads, or metadata are stored for forensic analysis, debugging, or compliance auditing. Post Processing System 502 may implement selective logging, where only packets matching specific criteria (e.g., security threats, unusual patterns) are recorded to optimize storage.

In another embodiment, Post Processing System 502 may apply packet timestamping to track arrival times, latency, or jitter. These timestamps may be used for performance monitoring, synchronization across distributed systems, or anomaly detection in time-sensitive applications. Post Processing System 502 may use hardware-based or software-based timestamps depending on accuracy requirements.

Post Processing System 502 may also support packet fragmentation and reassembly, ensuring compatibility with different network MTUs (Maximum Transmission Units). If packets exceed size limitations, they may be fragmented before transmission and reassembled upon receipt. Post Processing System 502 may order out-of-sequence fragments, detect missing pieces, and verify fragment integrity before reconstruction.

The Mobeus-Proxy and/or Mobeus-Gateway stack 500, in an embodiment, may be bidirectional, processing packets from Transport System 501 downward through Post Processing System 502, Translator 503, Filter/Capture System 504, and finally through Network Interface 505, where packets are sent out to the network. Likewise, incoming packets from Network Interface 505 are processed upward through Filter/Capture System 504, Translator 503, Post Processing System 502, and finally exit via Transport System 501 for delivery.

In one embodiment, Transport System 501 may utilize WebSockets for real-time, full-duplex communication between systems. WebSockets allow efficient bidirectional data exchange over a persistent connection, making them suitable for low-latency applications such as messaging, streaming, and interactive web applications.

In another embodiment, Transport System 501 may use TCP (Transmission Control Protocol) to ensure reliable, ordered, and error-checked packet delivery. This transport method is well-suited for applications requiring strict data integrity, such as file transfers, API communications, and database synchronization.

Transport System 501 may also support UDP (User Datagram Protocol) for low-latency, connectionless communication. This transport mechanism is ideal for time-sensitive applications such as VOIP, video streaming, and gaming, where occasional packet loss is acceptable in favor of speed.

In another embodiment, Transport System 501 may leverage QUIC (Quick UDP Internet Connections) to provide low-latency, multiplexed, and secure transport. QUIC, which underlies HTTP/3, enhances performance over traditional TCP by reducing connection setup time and improving congestion control.

Transport System 501 may employ MPLS (Multiprotocol Label Switching) for efficient packet forwarding based on labels rather than IP lookups. MPLS enables traffic engineering, supports Quality of Service (QoS), and improves network performance in large-scale enterprise and service provider environments.

In another embodiment, Transport System 501 may implement VXLAN (Virtual Extensible LAN) to encapsulate Layer 2 traffic over Layer 3 networks. This method is beneficial in virtualized data centers and cloud environments where scalable networking is required.

Transport System 501 may also support GRE (Generic Routing Encapsulation), allowing packets to be encapsulated and transported over an IP network. This method is useful for site-to-site tunneling, protocol bridging, and private networking.

In one embodiment, Transport System 501 may utilize IPsec (Internet Protocol Security) to ensure encrypted and authenticated packet delivery. IPsec can be used for secure VPN tunnels, protecting data integrity and confidentiality in transit.

Transport System 501 may integrate LISP (Locator/ID Separation Protocol) for improved mobility, scalability, and multihoming by separating identity from location. This enables dynamic routing and flexible network topologies in modern data centers.

In another embodiment, Transport System 501 may adopt SRv6 (Segment Routing over IPv6) to optimize routing without requiring MPLS. By encoding routing instructions within IPv6 headers, SRv6 improves scalability, simplifies network management, and enhances software-defined networking (SDN) implementations.

Transport System 501 may support Fiber Channel over IP (FCIP) for extending storage area networks (SANs) over IP-based infrastructures. This method enables remote storage replication and disaster recovery operations across geographically dispersed data centers.

In one embodiment, Transport System 501 may utilize ROCE (RDMA over Converged Ethernet) to enable low-latency, high-throughput networking for high-performance computing (HPC) environments. ROCE facilitates direct memory access between networked servers, reducing CPU overhead and improving data transfer speeds.

Transport System 501 may support ZeroMQ (ZMQ) for high-performance messaging across distributed systems. ZeroMQ offers asynchronous, brokerless communication and supports multiple transport layers, including TCP, inter-process communication (IPC), and multicast. This makes it ideal for real-time data exchange and event-driven architectures.

Transport System 501 may utilize Named Pipes or Unix Domain Sockets for inter-process communication (IPC) within the same system or across closely linked applications. Named Pipes provide an efficient method of data transfer between local processes without requiring network stack overhead, improving performance for microservices and containerized environments.

In one embodiment, Transport System 501 may use SSH Tunneling to securely transport data over an encrypted connection. SSH tunnels can encapsulate various transport protocols, allowing secure remote access and proxying of network traffic without requiring a dedicated VPN infrastructure.

Transport System 501 may integrate Bluetooth (RFCOMM, BLE) for wireless, low-power data transmission over short distances. Bluetooth can be used for IoT devices, proximity-based communication, and direct device-to-device networking. BLE (Bluetooth Low Energy) is optimized for minimal power consumption, making it ideal for sensor networks and wearables.

In another embodiment, Transport System 501 may employ LoRaWAN (Long Range Wide Area Network) for low-power, long-range wireless communication. LoRaWAN is particularly suited for IoT applications, such as environmental monitoring, industrial automation, and smart agriculture, where low bandwidth and extended battery life are priorities.

In another embodiment, Transport System 501 may employ any combination of existing or future transport mechanisms to facilitate data transmission across various network architectures. This includes, but is not limited to, connection-oriented and connectionless protocols, encrypted or unencrypted channels, wired or wireless technologies, and hardware-accelerated or software-defined transport layers. Transport System 501 may dynamically select the most appropriate transport based on performance, security, latency, and application requirements.

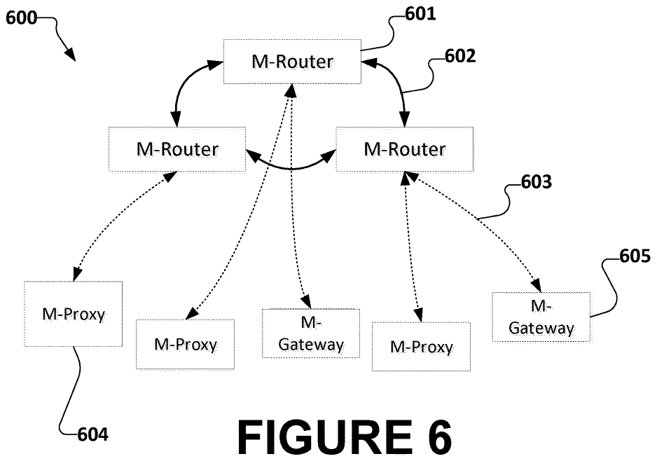

FIG. 6 illustrates a multi-tiered M-Router (Mobeus-Router) architecture (600) in one embodiment. This architecture enables router-to-router communication (601) and dynamic routing decisions (602, 603), facilitating efficient connectivity between M-Proxies (Mobeus-Proxies) (604) and M-Gateways (Mobeus-Gateways) (605).

In one embodiment, M-Routers (602) communicate with each other using direct peer-to-peer links to optimize routing paths and reduce latency. These connections may be established dynamically based on network conditions, predefined configurations, or metadata classification.

In one embodiments M-Router (601) to M-Router (601) connections (602) may take place over the public internet.

In other embodiments M-Router (601) to M-Router (601) connections (602) may utilize dedicated network links, including but not limited to Dark fiber for high-capacity private connectivity, MPLS (Multiprotocol Label Switching) for predictable routing and traffic engineering, Segment Routing (SR-MPLS or SRv6) for scalable and software-defined path selection, Point-to-Point (P2P) Wireless Links for high-speed interconnection without requiring physical fiber, Private IP links over enterprise WANs or service provider networks, Satellite or High-Frequency (HF) Radio Links for extreme remote connectivity.

In another embodiment, M-Router (601) to M-Router (601) links (602) may be redundant and load-balanced, ensuring resilience in case of link failures. This can be achieved via Equal-Cost Multi-Path Routing (ECMP), BGP Peering, or dynamic link-state protocols.

In another embodiment M-Router connections (602) may be encrypted and authenticated using IPsec, WireGuard, or TLS websockets, ensuring security even over untrusted network paths.

In another embodiment M-Routers (602) determine the most efficient route for each packet based on static routing tables or dynamically computed paths.

In another embodiment, static routes used by M-Router (602) to M-Router (602) may be preconfigured to enforce specific paths for predictable traffic flow. These routes may be used for dedicated enterprise links where traffic is known and consistent, Regulatory compliance where data must traverse specific regions, Low-latency financial transactions requiring guaranteed paths.

In another embodiment, dynamic routing used by a M-Router (602) may be determined based on metadata identified in Filter/Capture System 504 or Post Processing System 502. Routing decisions may consider Packet classification (Application type, QoS, VLAN, MPLS labels, INT tags) Security policies (e.g., route based on source-destination trust levels) Geolocation of source/destination devices Network conditions such as latency, congestion, and link availability.

In another embodiment an M-Router (602) may also leverage SDN (Software-Defined Networking) to programmatically adjust paths based on real-time conditions; ensuring traffic is always routed over the best available path.

In one embodiment a M-Proxies (604) and/or M-Gateways (605) rely on M-Routers for efficient path selection across multiple network infrastructures. These may include Fiber-optic networks (leased lines, dark fiber, or lit services), Private Ethernet-based WANs (e.g., Metro Ethernet), Carrier-grade MPLS networks (for predictable QoS-based routing), SD-WAN (Software-Defined WAN) overlaying multiple physical connections, Wireless P2P Links (e.g., microwave, mmWave, or 5G-based interconnects), Mesh-based networking for highly decentralized connectivity, IoT-specific networks (LoRaWAN, private LTE, or low-power LPWAN), or possibly just the standard IPV4 and/or IPV6 public internet.

In one embodiment, M-Gateways (605) may serve as secure ingress/egress points, applying NAT, encryption, or access controls before passing packets to their final destination.

In another embodiment, M-Proxies (604) may offload, compress, or cache specific traffic types to optimize throughput before passing it through M-Routers (601).

In another embodiment, M-Router (601) inspect traffic in real time, applying packet filtering, metadata tagging, and flow-based controls to enforce security policies.

M-Router (601) may support out-of-band signaling for traffic shaping, deep packet inspection (DPI), or real-time traffic redirection.

In another embodiment, encrypted tunnels may be dynamically established between M-Routers (602), ensuring end-to-end confidentiality and authenticity using WireGuard, IPsec, Private Link, TLS websockets, and/or QUIC-based VPNs.

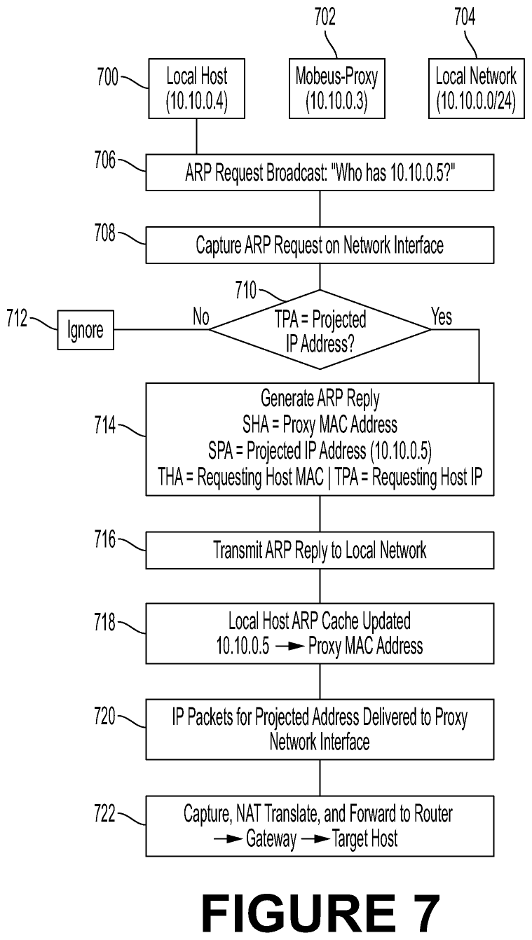

FIG. 7 illustrates an Address Resolution Protocol (ARP) handling flow, in accordance with one embodiment. As shown, the ARP handling process is performed by a Mobeus-Proxy component (702) to project a remote IP address onto a local network (704), including ARP request detection (708), target protocol address matching (710), ARP reply generation (714), ARP cache updating (718), and subsequent packet capture and forwarding (720, 722), in accordance with one embodiment.

The process enables the projection of a remote IP address onto a local network by causing local hosts to associate the projected IP address with the Mobeus-Proxy's MAC address in their ARP caches.

A local host 700 is connected to a local network 704 along with a Mobeus-Proxy 702. The local host 700 has a local IP address (e.g., 10.10.0.4), and the Mobeus-Proxy 702 has its own IP address on the local network (e.g., 10.10.0.3). The Mobeus-Proxy 702 is configured to project a remote IP address (e.g., 10.10.0.5) that corresponds to a remote target host accessible through the Mobeus network projection system.

At step 706, the local host 700 broadcasts an ARP Request onto the local network 704. The ARP Request contains a Target Protocol Address (TPA) set to the projected IP address (10.10.0.5). The ARP Request is a standard Layer 2 broadcast frame that is received by all devices on the local network segment, including the Mobeus-Proxy 702.

At step 708, the Mobeus-Proxy 702 captures the ARP Request on its network interface. The Mobeus-Proxy 702 monitors the network interface for ARP Request packets using the same capture mechanism (e.g., eBPF, pcap, raw sockets) used for IP packet capture.

At decision step 710, the Mobeus-Proxy 702 compares the Target Protocol Address (TPA) in the captured ARP Request with the projected IP address configured on the Mobeus-Proxy 702. If the TPA does not match the projected IP address, the Mobeus-Proxy 702 ignores the ARP Request at step 712, allowing the ARP Request to be processed normally by other devices on the local network 704.

If the TPA matches the projected IP address at decision step 710, the Mobeus-Proxy 702 proceeds to generate an ARP Reply at step 714. The ARP Reply is constructed with the following fields: the Sender Hardware Address (SHA) is set to the MAC address of the Mobeus-Proxy 702; the Sender Protocol Address (SPA) is set to the projected IP address (10.10.0.5); the Target Hardware Address (THA) is set to the MAC address of the requesting local host 700; and the Target Protocol Address (TPA) is set to the IP address of the requesting local host 700 (10.10.0.4).

At step 716, the Mobeus-Proxy 702 transmits the ARP Reply onto the local network 704. The ARP Reply is a unicast frame directed to the requesting local host 700.

At step 718, upon receiving the ARP Reply, the local host 700 updates its ARP cache to associate the projected IP address (10.10.0.5) with the MAC address of the Mobeus-Proxy 702. This ARP cache entry causes the operating system and network stack of the local host 700 to construct Ethernet frames destined for the projected IP address with the Mobeus-Proxy's MAC address as the destination MAC address.

At step 720, subsequent IP packets generated by the local host 700 and addressed to the projected IP address (10.10.0.5) are delivered to the network interface of the Mobeus-Proxy 702, because the Ethernet destination MAC address of these packets matches the Mobeus-Proxy's MAC address. The Mobeus-Proxy 702 captures these packets using the capture module described in connection with FIG. 5.

At step 722, the Mobeus-Proxy 702 captures the IP packets, performs NAT translation using the NAT table as described in connection with the Proxy Packet Flow, and forwards the translated packets through the transport connection to the Router and subsequently to the Gateway for delivery to the remote target host. Return packets from the remote target host traverse the reverse path through the Gateway, Router, and Proxy, and are injected onto the local network 704 with the projected IP address (10.10.0.5) as the source IP address, thereby completing the bidirectional projection.

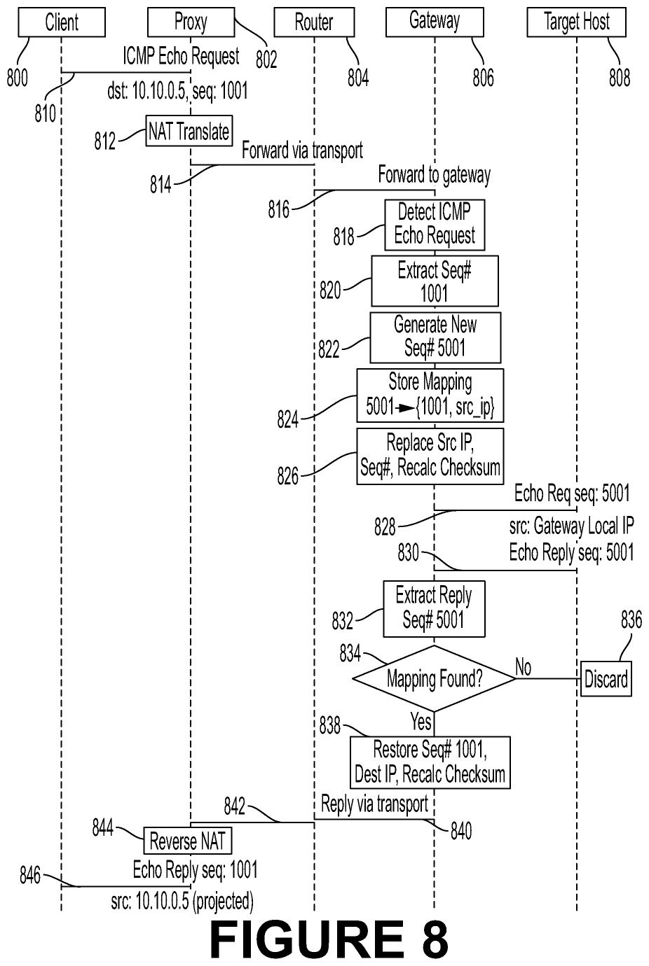

FIG. 8 illustrates an Internet Control Message Protocol (ICMP) echo request/reply handling flow, in accordance with one embodiment. As shown, the ICMP echo request/reply handling flow is performed through a Mobeus network projection system, including NAT translation at a Proxy component (802), forwarding through a Router component (804), sequence number exchange at a Gateway component (806), mapping storage (824), reverse lookup on reply (834), and transparent delivery of the Echo Reply to a Client (800) with the original sequence number restored, in accordance with one embodiment.

At step 810, the Client 800 generates an ICMP Echo Request packet (a standard “ping”) addressed to the projected IP address (e.g., 10.10.0.5) with a sequence number of 1001. Because the local host's ARP cache associates the projected IP address with the Proxy's MAC address (as described in connection with FIG. 7), the ICMP Echo Request packet is delivered to the network interface of the Proxy 802.

At step 812, the Proxy 802 performs NAT translation on the ICMP Echo Request packet. The Proxy 802 clears the source IP address, sets the mapping index into the source port field (or equivalent identifier field for ICMP), and stores the original source information in the NAT table. The translated packet is then forwarded to the Router 804 at step 814 via the transport connection (e.g., WebSocket).

At step 816, the Router 804 forwards the translated packet to the Gateway 806 via the linked transport connection.

At step 818, the Gateway 806 receives the translated packet and detects that it contains an ICMP Echo Request based on the IP protocol field and ICMP type field. At step 820, the Gateway 806 extracts the ICMP sequence number (1001) from the Echo Request packet.

At step 822, the Gateway 806 generates a replacement sequence number (e.g., 5001) that is unique within the Gateway's current mapping table. At step 824, the Gateway 806 stores a mapping entry associating the replacement sequence number (5001) with the original sequence number (1001) and the source IP address information needed to route the reply back to the originating Proxy 802.

At step 826, the Gateway 806 replaces the ICMP sequence number in the Echo Request with the replacement sequence number (5001), replaces the source IP address with the Gateway's local IP address on the target network, and recalculates the ICMP checksum to reflect the modified fields.

At step 828, the Gateway 806 transmits the modified ICMP Echo Request to the Target Host 808. The Target Host 808 receives the Echo Request as though it originated from the Gateway 806 (a local host on the target network) and processes it according to standard ICMP processing.

At step 830, the Target Host 808 generates a standard ICMP Echo Reply with the sequence number (5001) matching the received Echo Request and transmits it to the Gateway 806.

At step 832, the Gateway 806 receives the ICMP Echo Reply and extracts the sequence number (5001). At decision step 834, the Gateway 806 looks up the extracted sequence number in its mapping table. If no matching mapping is found, the Gateway 806 discards the packet at step 836 to prevent processing of unsolicited ICMP replies or replies to expired mappings.

If a matching mapping is found at decision step 834, the Gateway 806 proceeds to step 838, where it restores the original ICMP sequence number (1001) from the stored mapping, restores the destination IP address to the original source IP address, and recalculates the ICMP checksum.

At steps 840 and 842, the restored ICMP Echo Reply is transmitted from the Gateway 806 through the Router 804 to the Proxy 802 via the transport connections. At step 844, the Proxy 802 performs reverse NAT translation, restoring the source IP address to the projected IP address (10.10.0.5).

At step 846, the Proxy 802 injects the ICMP Echo Reply onto the local network with the projected IP address (10.10.0.5) as the source address and the Client's IP address as the destination. The Client 800 receives the Echo Reply with the original sequence number (1001), matching its outstanding Echo Request. From the perspective of the Client 800, the ping operation completed normally as though the projected IP address were a local network host, with no indication that the ICMP packets traversed multiple networks through the Mobeus projection system.

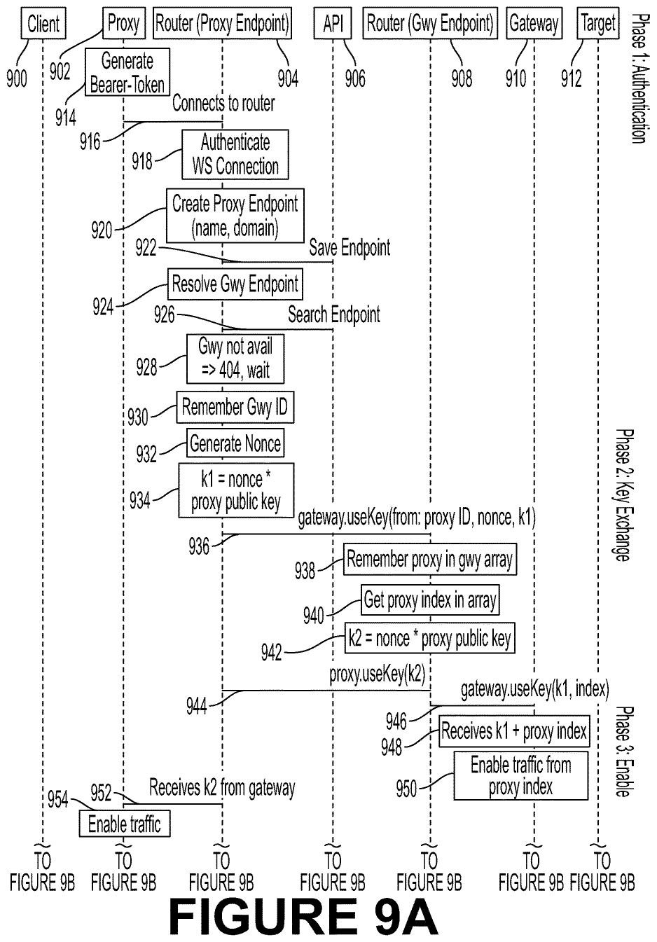

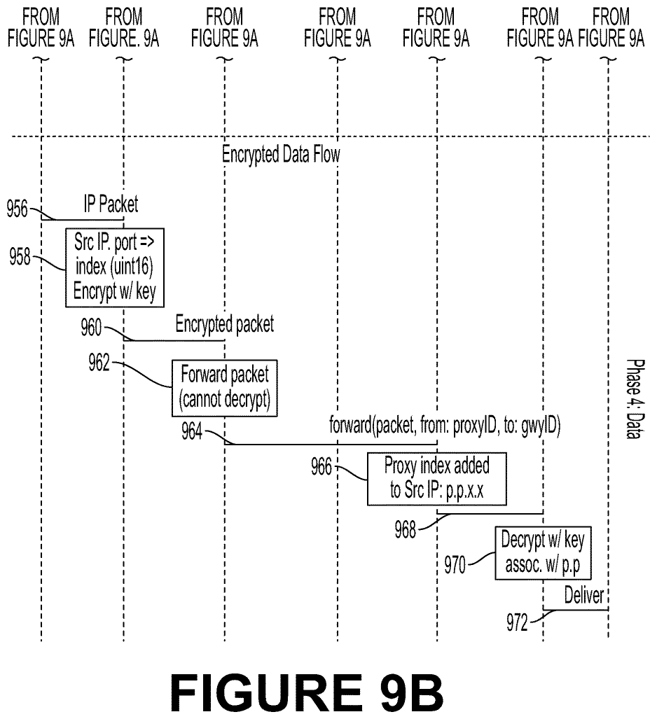

FIGS. 9A-B illustrate a session establishment and key exchange flow, in accordance with one embodiment. As shown, the flow is performed between a Client (900), a Proxy (902), a Router Proxy Endpoint (904), an API service (906), a Router Gateway Endpoint (908), a Gateway (910), and a Target Host (912), including bearer token authentication (914, 918), endpoint creation and resolution (920, 924), nonce generation and session key computation (932, 934, 942), proxy index assignment (940), session key distribution (936, 944, 946), and subsequent encrypted data flow with end-to-end encryption where the Router cannot decrypt packet contents (962), in accordance with one embodiment.

In Phase 1 (Authentication), at step 914, the Proxy 902 generates a bearer token. The bearer token is a cryptographic value that serves as an authentication credential for the Proxy's connection to the Router. At step 916, the Proxy 902 establishes a transport connection (e.g., a WebSocket connection) to the Router and presents the bearer token.

At step 918, the Router Proxy Endpoint 904 authenticates the WebSocket connection by validating the bearer token. Upon successful authentication, at step 920, the Router Proxy Endpoint 904 creates a proxy endpoint based on the name and domain associated with the authenticated Proxy 902. The name and domain are derived from the URI path or other identifying information presented during the connection.

At step 922, the Router Proxy Endpoint 904 saves the newly created endpoint to the API service 906. At step 924, the Router Proxy Endpoint 904 resolves the corresponding gateway endpoint by querying the API service 906 at step 926. If the gateway endpoint is not yet available (i.e., the Gateway 910 has not yet connected), the API service 906 returns a 404 response at step 928, and the Router Proxy Endpoint 904 holds the Proxy connection in a pending state until the Gateway 910 connects.

In Phase 2 (Key Exchange), at step 930, the Router Proxy Endpoint 904 stores the gateway identifier for subsequent routing. At step 932, the Router Proxy Endpoint 904 generates a nonce, which is a one-time random value used for the key exchange. At step 934, the Router Proxy Endpoint 904 computes a first session key k1 by combining the nonce with the public key of the Proxy 902 (k1=nonce*proxy public key).

At step 936, the Router Proxy Endpoint 904 transmits the first session key k1, the proxy identifier, and the nonce to the Router Gateway Endpoint 908 via a gateway.useKey message. At step 938, the Router Gateway Endpoint 908 stores the Proxy 902 as a member in the Gateway's array of associated proxy connections. At step 940, the Router Gateway Endpoint 908 obtains a proxy index representing the Proxy 902's position within the Gateway's proxy array. This proxy index is an integer value (e.g., 0, 1, 2) that uniquely identifies the Proxy 902 within the set of proxy connections associated with the Gateway 910.

At step 942, the Router Gateway Endpoint 908 computes a second session key k2 by combining the nonce with the public key of the Gateway 910 (k2=nonce*gateway public key). At step 944, the Router Gateway Endpoint 908 transmits the second session key k2 back to the Router Proxy Endpoint 904 via a proxy.useKey message. At step 946, the Router Gateway Endpoint 908 transmits the first session key k1 and the proxy index to the Gateway 910 via a gateway.useKey message.

At step 948, the Gateway 910 receives the first session key k1 and the proxy index. At step 950, the Gateway 910 enables traffic processing for packets associated with the received proxy index, associating the session key k1 with the proxy index for subsequent decryption.

In Phase 3 (Traffic Enablement), at step 952, the Router Proxy Endpoint 904 forwards the second session key k2 to the Proxy 902. At step 954, the Proxy 902 receives k2 and enables traffic forwarding using k2 as the encryption key for outbound packets. At this point, both the Proxy 902 and the Gateway 910 possess the session keys necessary for end-to-end encrypted communication.

In Phase 4 (Encrypted Data Flow), at step 956, the Client 900 sends an IP packet to the Proxy 902. At step 958, the Proxy 902 sets the source IP port to an index value encoded as a uint16 identifier, clears the source IP address (setting it to 0.0.x.x), and encrypts the packet using the session key. At step 960, the Proxy 902 transmits the encrypted packet to the Router Proxy Endpoint 904 via the transport connection.

At step 962, the Router Proxy Endpoint 904 receives the encrypted packet. Importantly, the Router does not possess the private keys of either the Proxy 902 or the Gateway 910, and therefore cannot decrypt the packet contents. The Router forwards the encrypted packet based solely on the stored proxy-to-gateway association. At step 964, the Router forwards the packet from the proxy identifier to the gateway identifier via a forward message.

At step 966, the Router Gateway Endpoint 908 receives the forwarded packet and adds the proxy index to the source IP address field, creating a per-proxy source IP address (p.p.x.x) that allows the Gateway 910 to demultiplex packets from multiple Proxy connections. At step 968, the packet is delivered to the Gateway 910.

At step 970, the Gateway 910 decrypts the packet using the session key associated with the proxy index (p.p). At step 972, the Gateway 910 delivers the decrypted packet to the Target Host 912 after reconstructing the IP and Ethernet headers with the Gateway's local IP address and the Target Host's IP address, as described in connection with the Gateway Packet Flow.

The key exchange protocol illustrated in FIGS. 9A-B provides several security properties. First, the Router 904/908 operates as a blind relay, forwarding encrypted data without the ability to inspect packet contents, thereby limiting the attack surface of the routing infrastructure. Second, the nonce ensures that each session uses unique session keys, providing forward secrecy such that compromise of a session key does not expose data from previous or subsequent sessions. Third, the proxy index multiplexing mechanism enables a single Gateway 910 to securely serve multiple Proxy connections simultaneously, with each connection using independent session keys.

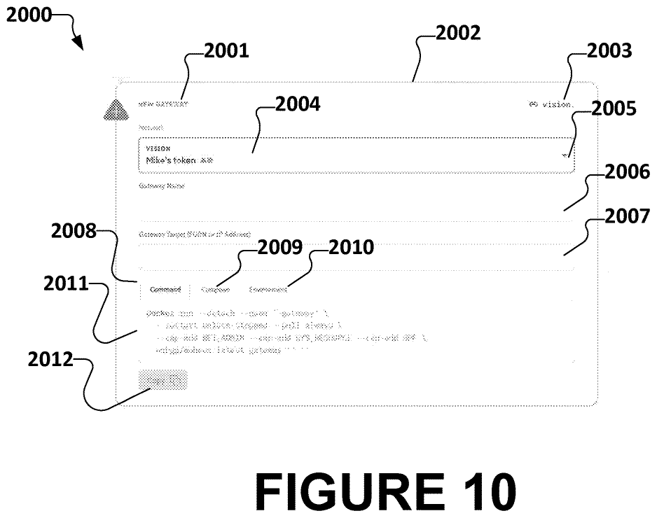

FIG. 10 illustrates a user interface (2000) to configure a M-Gateway (414) in one embodiment.

In other embodiments, the interface to control or define a M-Gateway (414) may be an Rest API, GraphQL API, a MCP or other non UI controllable interface.

In another embodiment, User interface (2000) is characterized by a grid-like background. An embodiment may take this form.

In one embodiment, a complete gateway configuration UI may be framed a border (2002) that visually highlights the top boundary of the section containing gateway details. The UI may start with a header section (2001) titled “NEW GATEWAY,” which is placed prominently at the top-left of the interface. It includes a “+” icon to suggest addition. A section indicator or label in this example marked vision (2003) may corresponds to the selected network or/or group configuration. In UI component 2004 A dropdown selector (2005) for the network. In the displayed state, the dropdown has “VISION” selected, with “Mike's token” as an option or descriptor. A small triangular arrow indicates the ability to expand the dropdown menu for more options, in this embodiment a clickable dropdown expansion button to select or modify the network (2005). An input field labeled “Gateway Name” (2006) that is blank, designed to accept the name for the gateway target being configured. The Gateway Target (2007) is an input field, intended to capture the target hostname or IP address for the gateway to target. UI element 2008 is multi-faceted, shown in the selected state “Command” displays in this case a docker run command (2011) that can be used to create this gateway on a system. Tab 2009 may give you information or the specific Docker Compose command that may be used to start this gateway component. Finally tab 2010 may give you the environment/environment variables information needed to run the Docker commands. Finally the copy button (2012) allows information to be copied to the clipboard so it can later be pasted into a terminal and/or editor or other run command environment.

The above UI element in FIG. 10 is just one embodiment, other embodiments may be focused not on Docker, in other embodiments the system may include a user interface configured to generate and initiate execution commands for deploying software instances across a variety of runtime environments. These environments may include container-based runtimes (such as Docker, Podman, or containerd), bare-metal or host-based execution contexts (including direct invocation via shell or managed services such as systemd), virtual machine and hypervisor-based environments (such as those utilizing QEMU, KVM, VirtualBox, or Firecracker), and orchestration or platform-based systems (including but not limited to Kubernetes, Nomad, or Docker Swarm). The system may produce environment-specific scripts, configuration files, or control instructions tailored to the selected execution context, thereby enabling consistent deployment logic across heterogeneous infrastructure types.

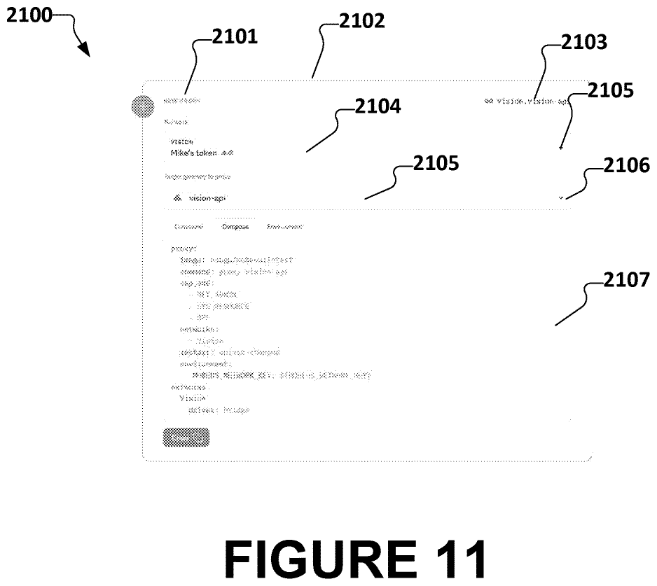

FIG. 11 illustrates a user interface (2100) configured to define a proxy instance for an M-Gateway (414) in one embodiment.

In other embodiments, the proxy configuration interface may be accessed or controlled programmatically, for example, via a REST API, GraphQL API, Machine Control Protocol (MCP), or other machine-driven or headless interfaces.

In one embodiment, user interface (2100) may be visually defined by a bounding border (2102), enclosing a configuration module for a new proxy instance. The top section includes a header (2101) labeled “NEW PROXY,” which is visually prominent and optionally includes a “+” symbol to indicate creation of a new entity. A sub-label (2103) may display the computed or assigned identifier for the resulting proxy instance (in this case, “vision.vision-api”).

A section (2104) displays the selected network context for the proxy configuration. In the illustrated embodiment, the network is labeled “VISION” and described by a token string, here shown as “Mike's token.” This section may include a visual dropdown selector or summary UI for the current network configuration.

An interface element (2105) is shown in the selected state and indicates the target M-Gateway to be proxied. In the present example, the selected gateway is labeled “vision-api,” and may be rendered as a selectable item, dropdown entry, or menu selection, possibly accompanied by a dropdown expansion control (2106) to change the target.

The lower portion of the interface (2107) includes a tabbed control surface, with the “Compose” tab selected. This tab displays a YAML-formatted docker-compose configuration block used to deploy the proxy. This configuration includes fields for the image, command, capability additions (e.g., NET_ADMIN, SYS_RESOURCE, BPF), restart policy, environment variables (e.g., MOBEUS_NETWORK_KEY), and networking parameters.

A copy control element (Copy button) is provided to enable one-click copying of the generated configuration for use in terminals, text editors, CI pipelines, or deployment automation tools.

The embodiment shown in FIG. 11 illustrates one possible UI rendering. In other embodiments, the system may be configured to output proxy definitions for a variety of runtime environments including, but not limited to, container runtimes (e.g., Docker, Podman), bare-metal executions (e.g., systemd service), virtualized environments (e.g., QEMU, VirtualBox, Firecracker), or orchestration platforms (e.g., Kubernetes, Nomad). The UI or API may produce environment-specific configuration files (e.g., YAML, JSON, Bash scripts) appropriate to the selected execution target, enabling consistent proxy deployment across heterogeneous infrastructure types.

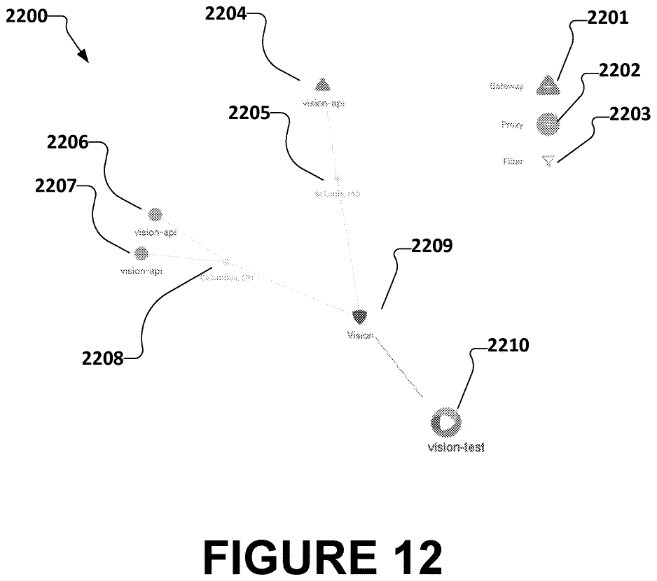

FIG. 12 illustrates a graphical network visualization interface system (2200) for visualizing and/or managing gateway and proxy components within a distributed system architecture, in accordance with one embodiment.

In this embodiment, the interface includes a control cluster (2201) located near the top-right of the UI, comprising buttons for creating or managing key components. A first control (2202) includes a gateway creation button, visually indicated with an orange triangle and a “+” symbol. A second control (2203) provides a similar button for creating or adding a proxy, represented with a blue circle and a “+” symbol. A third control represents a filter toggle icon (depicted as a funnel), which may be used to filter out inactive, offline, or non-responsive devices from the network view.

The visualization depicts active and connected components within a logical or physical network. An online gateway node (2204) labeled “vision-api” is shown connected to the “Vision” network (2209), which is centrally positioned in the network graph. The node (2204) may be rendered using a unique shape or color (e.g., orange triangle) to distinguish its type. The connection is annotated or co-located with a geographic location label (2205), in this example “St. Louis, MO,” representing the gateway's reported physical or logical region.

Additional proxy instances (2206, 2207), also labeled “vision-api,” are shown connected to the same “Vision” network (2209), with implied or inferred location metadata such as “Columbus, OH.” These proxy instances may be visually represented as blue circular nodes, corresponding to the proxy legend indicated in control (2203).

The “Vision” network itself is shown as a central connecting node (2209), establishing visual and logical relationships to all participating gateways and proxies. In one embodiment, this network representation includes metadata or identifiers indicating network ownership, administrative grouping, or domain affiliation.

In this embodiment, the “Vision” network (2209) is owned or managed under the domain or organization “vision-test” (2210), which may be visually annotated with an associated symbol or logo to reflect branding or organizational identity. This entity (2210) may also represent a tenant, customer, or namespace boundary within a multi-tenant infrastructure.

The visual structure in FIG. 12 is just one embodiment of a system that dynamically renders live status, connectivity, and administrative relationships between distributed deployment nodes (gateways, proxies, filters) and network domains. In other embodiments, this system may integrate geolocation, performance metrics, security posture, or lifecycle states, and may permit interaction, such as selecting, editing, or deploying new nodes directly from the visualization interface

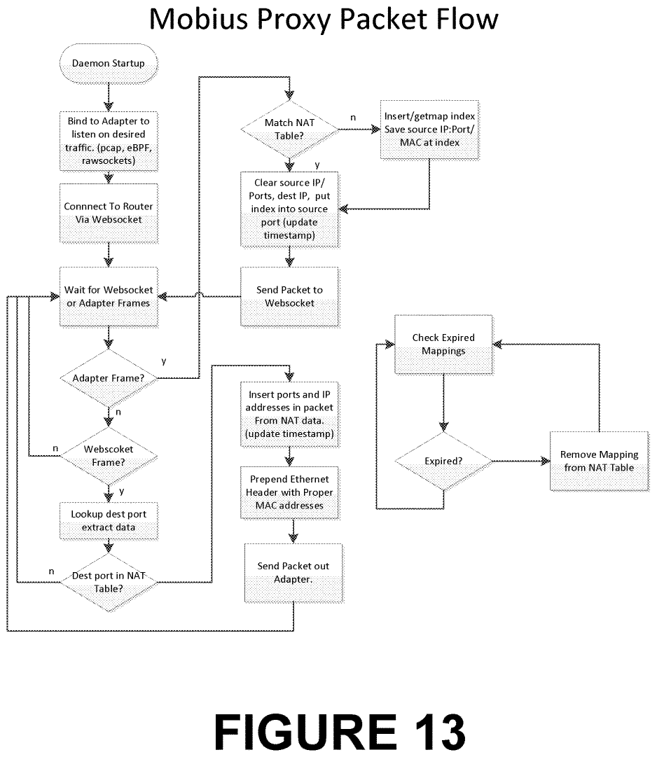

FIG. 13 illustrates the Mobius Proxy Packet Flow, in accordance with one embodiment. As shown, the Mobeus-Proxy daemon processes packets in two primary paths: an outbound path in which packets received on the local network adapter are NAT-translated and forwarded to the Router via WebSocket transport, and a return path in which WebSocket frames received from the Router are reverse-NAT-translated and injected back onto the local network adapter, in accordance with one embodiment.

At Daemon Startup, the Mobeus-Proxy initializes its operating environment. The proxy then binds to the network adapter using one of the supported capture mechanisms, including pcap, eBPF, or raw sockets, to intercept desired network traffic at the packet level. The proxy subsequently establishes a persistent WebSocket connection to the Router, which serves as the transport channel for forwarding and receiving encapsulated network packets.

Following initialization, the daemon enters a main event loop designated as Wait for WebSocket or Adapter Frames. In this loop, the daemon concurrently monitors both the local network adapter for inbound IP packets and the WebSocket connection for frames received from the Router.

In the outbound direction, when an Adapter Frame is detected, the daemon determines whether the packet matches an existing entry in the NAT table. If a matching entry is found, the daemon clears the source IP address and source port fields, clears the destination IP field, and encodes the NAT table index value into the source port field, updating the entry timestamp to reflect the current time. The modified packet is then forwarded to the Router via the WebSocket transport. If no matching NAT table entry exists, the daemon allocates a new NAT table index using an insert/getmap operation, records the original source IP address, source port, and MAC address at that index, applies the same field transformations described above, and forwards the packet to the Router.

In the return direction, when a WebSocket Frame is received, the daemon inspects the destination port field of the packet to determine whether it corresponds to a valid NAT table entry. If a matching entry is found, the daemon performs a lookup on the destination port to extract the stored NAT data, restores the original source and destination IP addresses and port values from the NAT data into the packet headers, updates the NAT entry timestamp, prepends an Ethernet frame header constructed with the appropriate source and destination MAC addresses recovered from the NAT table, and transmits the fully reconstructed packet outbound on the network adapter. If no matching NAT table entry is found for the destination port, the WebSocket frame is discarded.

In parallel with the main packet processing loop, the daemon periodically invokes a Check Expired Mappings routine. This routine iterates over all current NAT table entries and evaluates each entry against a configurable idle timeout threshold. NAT table entries whose timestamps indicate that no packets have been processed within the timeout period are removed from the NAT table, freeing the associated index for reuse.

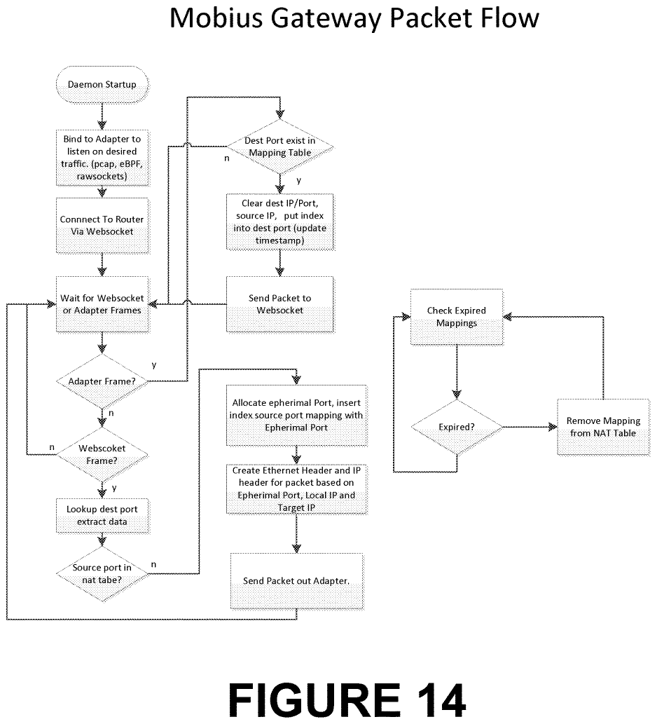

FIG. 14 illustrates the Mobius Gateway Packet Flow, in accordance with one embodiment. As shown, the Mobeus-Gateway daemon processes packets in two primary paths: an outbound path in which packets received on the local target-side network adapter are NAT-translated and forwarded to the Router via WebSocket transport, and a return path in which WebSocket frames received from the Router are translated using ephemeral port mappings and injected as fully constructed IP and Ethernet frames onto the target network, in accordance with one embodiment.

At Daemon Startup, the Mobeus-Gateway initializes and binds to the local network adapter using a supported capture interface (pcap, eBPF, or raw sockets), then establishes a persistent WebSocket connection to the Router. The daemon then enters a Wait for WebSocket or Adapter Frames event loop, concurrently monitoring the local adapter and the WebSocket connection.

In the outbound direction, when an Adapter Frame arrives, the daemon inspects whether the destination port of the received packet exists in the Gateway Mapping Table. If a matching entry is found, the daemon clears the destination IP address and destination port fields, clears the source IP field, encodes the mapping table index into the destination port field with an updated timestamp, and forwards the translated packet to the Router via the WebSocket connection. If no matching mapping table entry is found for the destination port, the packet is discarded.

In the return direction, when a WebSocket Frame is received, the daemon inspects the source port field to determine whether it corresponds to an existing NAT table entry. If a matching entry is found, the daemon performs a destination port lookup to extract the stored NAT data and proceeds with packet reconstruction. If no source port match is found in the NAT table, the daemon allocates an ephemeral port, creates a new source port mapping entry associating the ephemeral port with the NAT table index, constructs an Ethernet header and an IP header for the outbound packet based on the ephemeral port, the Gateway local IP address, and the configured Target IP address, and transmits the fully reconstructed packet out the network adapter. The Check Expired Mappings routine operates in parallel as described for the Proxy, removing stale NAT table entries upon expiration.

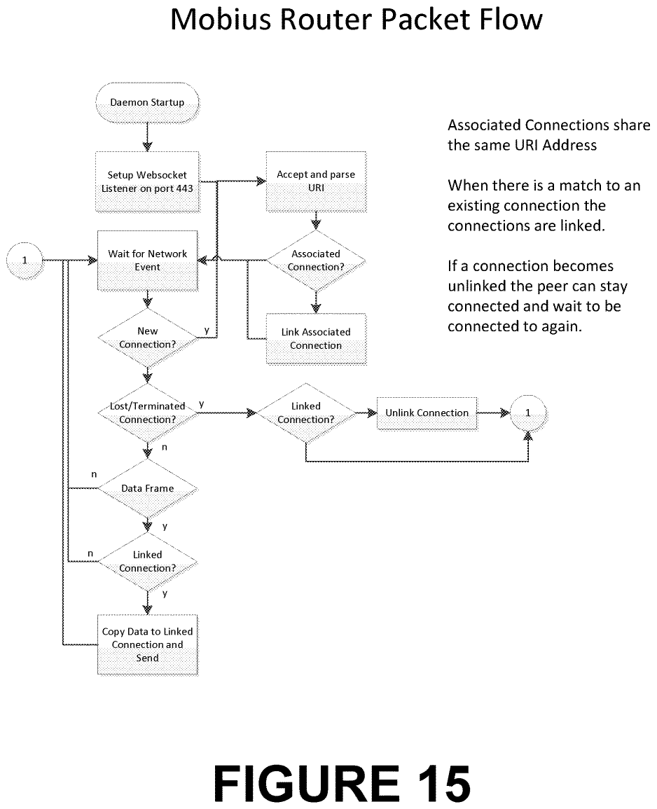

FIG. 15 illustrates the Mobius Router Packet Flow, in accordance with one embodiment. As shown, the Mobeus-Router daemon manages WebSocket connections from both Proxy and Gateway endpoints, links associated connection pairs that share a common URI address, and provides transparent bidirectional data relay between linked connections, in accordance with one embodiment.

At Daemon Startup, the Router sets up a WebSocket listener on port 443. The daemon then enters a Wait for Network Event loop. Upon receiving a new connection event, the daemon accepts the incoming WebSocket connection and parses its URI to determine the routing identity. The daemon then queries whether an associated connection sharing the same URI address already exists. If an associated connection is found, the two connections are linked to one another, establishing a bidirectional relay path. As annotated in FIG. 15, associated connections share the same URI address, and when a match to an existing connection is made, the connections are linked. If a connection subsequently becomes unlinked due to disconnection of one peer, the remaining peer may stay connected and wait to be connected to again when a new associated connection arrives.

When a data frame event is received on a linked connection, the Router copies the data frame to the peer linked connection and transmits it without inspection or decryption. When a lost or terminated connection event is received, the Router determines whether the terminated connection had a linked peer. If a linked peer exists, the Router unlinks the connection pair, returning the peer connection to a waiting state. If no linked peer is found, the event is discarded and the daemon returns to the Wait for Network Event state.

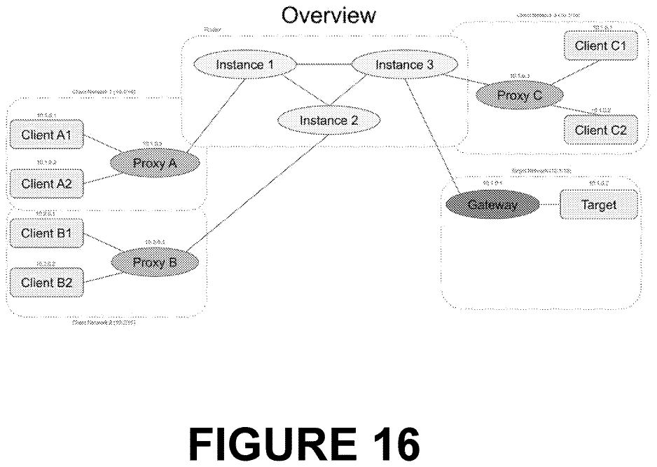

FIG. 16 illustrates a system overview topology diagram showing a multi-proxy to single gateway deployment, in accordance with one embodiment. As shown, a Router component is centrally positioned and instantiated as three Router instances (Instance 1, Instance 2, and Instance 3), each providing WebSocket relay capacity within the Mobeus network projection system.

In the illustrated embodiment, Client Network 1 (address space 10.1/16) contains clients A1 (10.1.0.1) and A2 (10.1.0.2), served by Proxy A at address 10.1.0.3. Client Network 2 (address space 10.2/16) contains clients B1 (10.2.0.1) and B2 (10.2.0.2), served by Proxy B at address 10.2.0.3. Client Network 3 (address space 10.1/16) contains clients C1 (10.1.0.1) and C2 (10.1.0.2), served by Proxy C at address 10.1.0.3. Each Proxy connects to the Router instances via WebSocket transport. On the target side, a single Target Network (address space 10.1/16) contains a Gateway at 10.1.0.1 and a Target host at 10.1.0.2. This topology demonstrates that multiple independent client networks, each with overlapping or distinct address spaces, may simultaneously project connectivity to a shared target through a common Gateway, with the Router instances providing the relay fabric.

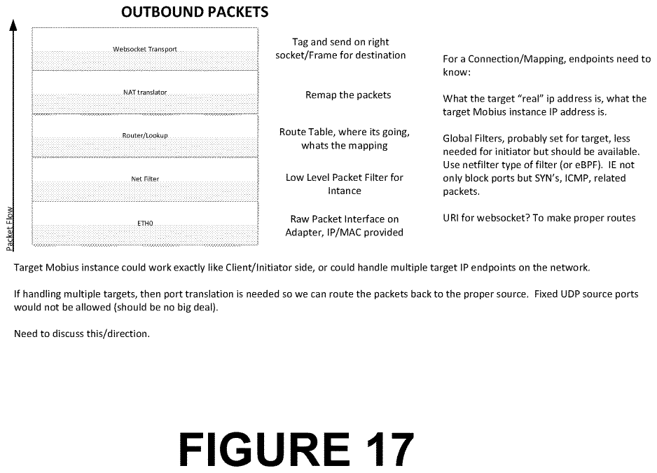

FIG. 17 illustrates the outbound packet flow stack for a Mobeus node, in accordance with one embodiment. As shown, the outbound packet processing stack is organized as a sequence of five layers through which packets are processed from the physical network interface toward the WebSocket transport, in accordance with one embodiment. The stack layers from bottom to top are: ETH0, Net Filter, Router/Lookup, NAT Translator, and Websocket Transport.

As annotated in FIG. 17, the ETH0 layer represents the raw packet interface on the network adapter, providing access to raw IP and MAC frame data. The Net Filter layer provides a low-level packet filtering function, serving as the instance-specific filter for controlling which packets are admitted to the processing pipeline; in one embodiment this layer may employ eBPF or netfilter-style filtering to block or pass packets based on protocol, port, SYN flag, ICMP type, or other packet attributes. The Router/Lookup layer consults the route table to determine where a packet is destined and what mapping applies. The NAT Translator layer remaps packet headers, rewriting source and destination IP addresses and port fields according to the NAT table as described in connection with FIGS. 13 and 14. The Websocket Transport layer tags the processed packet and sends it on the appropriate WebSocket socket or frame for delivery to the connected peer. For a connection or mapping, endpoints are required to know the target real IP address and the target Mobeus instance IP address.

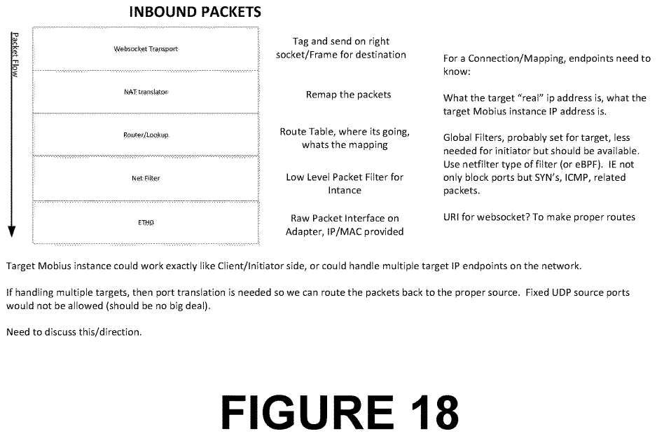

FIG. 18 illustrates the inbound packet flow stack for a Mobeus node, in accordance with one embodiment. As shown, the inbound packet processing stack is the mirror image of the outbound stack illustrated in FIG. 17, with the packet flow direction reversed: packets arrive via Websocket Transport and are processed downward through NAT Translator, Router/Lookup, Net Filter, and finally ETH0, where they are injected onto the local network adapter, in accordance with one embodiment. The layer descriptions and functional roles are symmetric to those described in connection with FIG. 17.

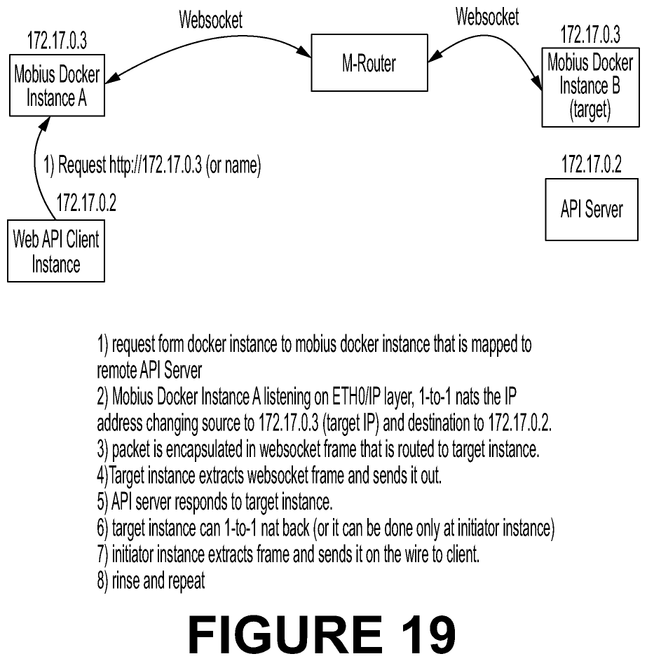

FIG. 19 illustrates a Docker-to-Docker packet flow diagram depicting two Mobeus Docker instances communicating through an M-Router, in accordance with one embodiment. In the illustrated embodiment, Mobeus Docker Instance A is assigned IP address 172.17.0.3 on the left side of the diagram, and Mobeus Docker Instance B (acting as the target) is assigned IP address 172.17.0.3 on the right side. A Web API Client instance at IP address 172.17.0.2 issues a request directed to 172.17.0.3. Mobeus Docker Instance A listens on the ETH0 and IP layer and performs a one-to-one NAT translation, changing the source address to 172.17.0.3 (the target IP) and the destination to 172.17.0.2. The packet is encapsulated in a WebSocket frame and routed to the target instance via the M-Router. The target instance extracts the WebSocket frame and sends the packet outbound. The API Server at 172.17.0.2 on the target side responds to the target instance. The target instance may perform a one-to-one NAT reverse translation, or the reverse NAT may be performed at the initiator instance. The initiator instance extracts the returning frame and delivers it on the wire to the client. This eight-step flow, as annotated in FIG. 19, demonstrates the full round-trip packet lifecycle across a Mobeus Docker network overlay.

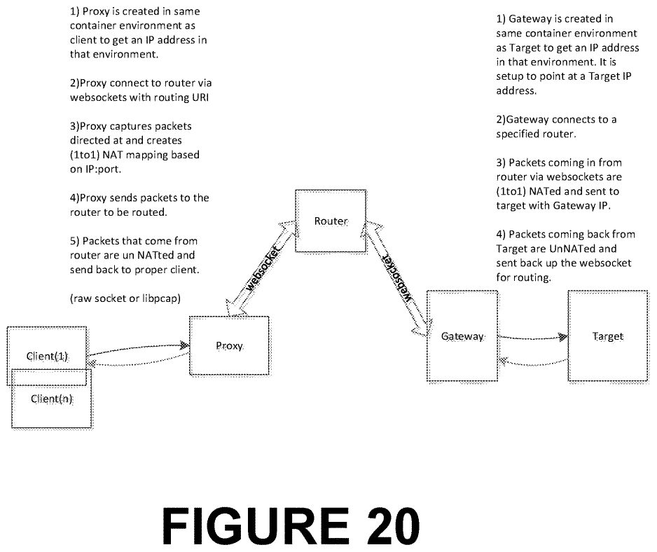

FIG. 20 illustrates a Proxy-Router-Gateway packet flow diagram annotated with the roles and operational steps performed by each component, in accordance with one embodiment. As shown, the Proxy is deployed within the same container environment as the client hosts, acquiring an IP address in that environment. The Proxy connects to the Router via a WebSocket using a routing URI. The Proxy captures packets directed at the projected IP address and creates a one-to-one NAT mapping based on IP address and port. The Proxy forwards the NAT-translated packets to the Router. Return packets received from the Router are reverse-NAT-translated by the Proxy and delivered back to the originating client via raw socket or libpcap. The Gateway is similarly deployed within the same container environment as the Target, acquiring a local IP address in the target environment and configured to point at a specific Target IP address. The Gateway connects to the designated Router. Packets arriving from the Router via WebSocket are one-to-one NAT-translated by the Gateway and forwarded to the Target using the Gateway IP address as the source. Return packets from the Target are reverse-NAT-translated by the Gateway and transmitted back up the WebSocket to the Router for routing to the originating Proxy.

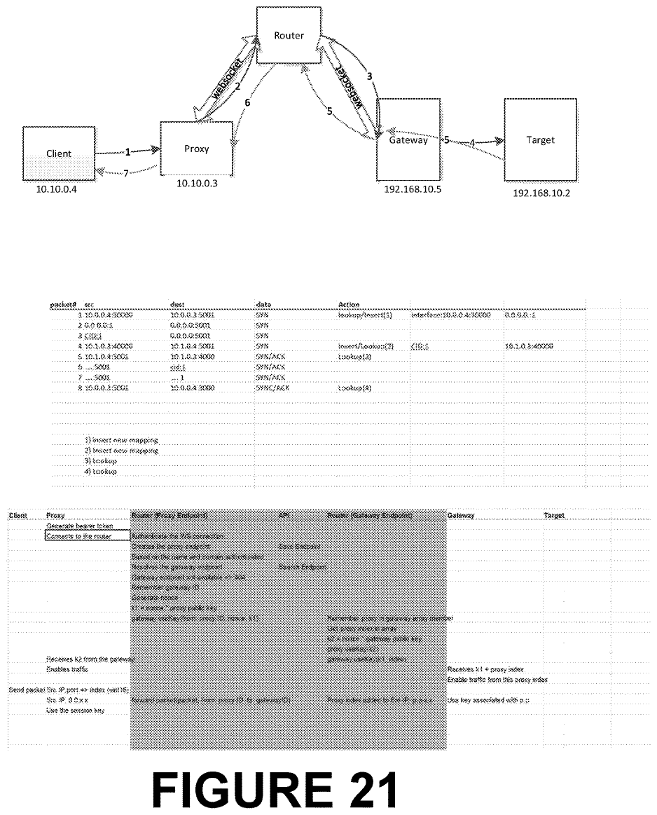

FIG. 21 illustrates a composite diagram combining the session establishment sequence and a proxy-to-gateway packet trace table, in accordance with one embodiment. The upper portion of FIG. 21 presents a topological flow diagram showing a Client at address 10.10.0.4 communicating through a Proxy at 10.10.0.3, a Router, a Gateway at 192.168.10.5, and a Target at 192.168.10.2, with numbered arrows indicating the packet flow sequence. The lower portion presents a packet trace table and a session establishment sequence table corresponding to the flow. As the content of FIG. 21 is substantially the same as the session establishment and key exchange flow described in connection with FIG. 9, reference is made to paragraphs 277 through 290 for the detailed step-by-step description of the authentication, key exchange, traffic enablement, and encrypted data flow phases illustrated therein.

### XDP/Bare Metal Embodiment

In one embodiment, the Mobeus-Proxy or Mobeus-Gateway component operates on bare metal hardware rather than within a containerized or virtualized environment. When operating on bare metal, the component uses XDP (eXpress Data Path) to capture network packets at the network interface driver level before they enter the host system's network stack. In this embodiment, the XDP program is configured to capture all traffic destined for a designated CIDR range (e.g., 10.0.0.0/8) representing the bridge network address space, and to capture traffic addressed to the host's local IP address only when the destination port falls within a designated ephemeral port range (e.g., ports 20000-29999). Traffic to the host's local IP address on ports outside the designated range is not captured, ensuring that normal host networking operations are not disrupted.

In this bare metal embodiment, outbound packets are injected onto the network interface using pcap rather than XDP injection. The component uses the host's local IP address as the source IP address for all injected packets, and performs NAT translation using only the designated port range (e.g., ports 20000-29999) so that return traffic can be identified and captured by the XDP program. This separation of capture (via XDP) and injection (via pcap) ensures that the host system can receive both bridge-projected traffic and standard local traffic on the same network interface.

### ICMP Handling Embodiment

In one embodiment, the Mobeus-Gateway component includes specialized handling for ICMP (Internet Control Message Protocol) Echo Request packets. When the gateway component receives an ICMP Echo Request packet from the router component destined for the target host, the gateway component extracts the ICMP sequence number from the packet, generates a gateway-specific replacement sequence number, and stores a mapping between the original sequence number and the replacement sequence number along with the source IP address. The gateway component replaces the sequence number in the ICMP Echo Request with the replacement sequence number, replaces the source IP address with the gateway's local IP address, recalculates the ICMP checksum, and forwards the modified packet to the target host.

Upon receiving an ICMP Echo Reply from the target host, the gateway component extracts the sequence number from the reply and looks up the stored mapping. If no matching mapping is found, the gateway component discards the packet to prevent processing of unsolicited ICMP replies. If a matching mapping is found, the gateway component restores the original sequence number, sets the destination IP address to the stored original source IP address, recalculates the ICMP checksum, and transmits the restored ICMP Echo Reply to the router component for delivery to the proxy component. This mechanism enables standard ping operations to work transparently through the Mobeus network projection, allowing operators and monitoring systems to verify connectivity to the projected IP address. As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

### Embodiment A

A system, method and computer program product are provided for network IP projection. Included is:
a proxy component executing on a first computing device connected to a first network, the proxy component comprising:
a capture module configured to intercept packets on a network interface of the first computing device before the packets reach a host TCP/IP stack, the intercepted packets being addressed to a projected IP address associated with a remote target host on a second network;
a network address translation (NAT) table configured to store mappings between local connection attributes on the first network and corresponding translated connection attributes;
a translation module configured to translate the intercepted packets by replacing at least a source IP address and a source port with translated values from the NAT table and setting a mapping index in the translated packet; and
a transport interface configured to transmit the translated packets over a transport connection to a router component;
the router component executing on a second computing device, the router component comprising:
a transport listener configured to accept incoming transport connections from proxy components and gateway components;
a connection linking module configured to associate a transport connection from the proxy component with a transport connection from a gateway component based on a matching identifier, forming a bidirectional data path; and
a forwarding module configured to forward data received on one linked transport connection to the other linked transport connection;
a gateway component executing on a third computing device connected to the second network, the gateway component comprising:
a receiving module configured to receive translated packets from the router component via a transport connection;
an ephemeral port allocation module configured to allocate ephemeral ports on the second network for received translated packets;
a reconstruction module configured to reconstruct received translated packets by replacing the translated values with the gateway component's local IP address as a source address and the allocated ephemeral port as a source port, and setting the destination address to the IP address of the remote target host; and
an injection module configured to inject the reconstructed packets onto the second network for delivery to the remote target host;
wherein the combination of the proxy component, the router component, and the gateway component causes the projected IP address to appear on the first network as a local network entity, such that hosts on the first network communicate with the projected IP address without any software installation, configuration change, or routing modification on the hosts, and the remote target host receives packets as though they originated from a local host on the second network.

### Embodiment A.1

Further to embodiment A, where the proxy component further comprises an ARP response module configured to: monitor the network interface for Address Resolution Protocol (ARP) Request packets whose Target Protocol Address matches the projected IP address; and upon detecting such an ARP Request, generate and transmit an ARP Reply containing the proxy component's own MAC address as the Sender Hardware Address and the projected IP address as the Sender Protocol Address, thereby causing hosts on the first network to direct packets for the projected IP address to the proxy component's network interface.

### Embodiment A.2

Further to embodiment A.1, where the proxy component further broadcasts a Gratuitous ARP announcement upon startup or upon configuration change, the Gratuitous ARP containing the projected IP address and the proxy component's MAC address as both the Sender and Target Protocol Addresses, thereby pre-populating ARP caches of hosts on the first network.

### Embodiment A.3

Further to embodiment A, where further included is an authentication and key exchange protocol wherein:
the proxy component generates a bearer token and authenticates a transport connection to the router component using the bearer token;
the router component creates a proxy endpoint based on a name and domain associated with the authenticated proxy component, resolves a corresponding gateway endpoint, stores a gateway identifier, generates a nonce, and computes a first session key by combining the nonce with a public key of the proxy component;
the router component transmits the first session key, a proxy identifier, and the nonce to the gateway component;
the gateway component stores the proxy component in an array of associated proxy connections, obtains a proxy index within the array, computes a second session key by combining the nonce with a public key of the gateway component, and transmits the second session key and the proxy index to the router component;
the router component forwards the second session key to the proxy component; and
thereafter, the proxy component and the gateway component encrypt packet data using the respective session keys, such that the router component forwards encrypted packet data without the ability to decrypt the packet contents.

### Embodiment A.4

Further to embodiment A.3, where the proxy index is an integer value representing the proxy component's position within the gateway component's array of connected proxy components, and the gateway component uses the proxy index to demultiplex incoming packets from multiple proxy components sharing the same gateway endpoint, and adds the proxy index to a source IP address field to create a unique per-proxy source IP address visible to the remote target host.

### Embodiment A.5

Further to embodiment A.3, where the capture module intercepts packets using at least one of: extended Berkeley Packet Filter (eBPF) programs loaded into the kernel to process packets before the host TCP/IP stack, eXpress Data Path (XDP) programs executing at the network interface driver level, packet capture (pcap) library, or the /dev/bpf interface.

### Embodiment A.6

Further to embodiment A, where each entry in the NAT table includes a timestamp indicating a last-used time, and the proxy component periodically removes entries whose last-used time exceeds a configurable expiration threshold.

### Embodiment A.7

Further to embodiment A.6, where the NAT table further comprises connection state tracking entries that track TCP connection states including at least SYN_SENT, ESTABLISHED, and CLOSED, and the proxy component uses the tracked connection state to determine appropriate timeout values for NAT table entries, such that entries in ESTABLISHED state have a longer expiration threshold than entries in other states.

### Embodiment A.8

Further to embodiment A, where the transport connection between the proxy component and the router component, and between the router component and the gateway component, uses at least one of: WebSocket over TLS, QUIC, TCP, or UDP.

### Embodiment A.9

Further to embodiment A, where the matching identifier used by the connection linking module comprises at least one of: a URI path component, a shared cryptographic key, a bearer token, a certificate common name, a pre-configured route identifier, or a network name, and the connection linking module maintains the association such that data received on one linked connection is forwarded to the other.

### Embodiment A.10

Further to embodiment A, where the gateway component further comprises an ICMP handling module configured to: upon receiving an ICMP Echo Request packet from the router component, replace the ICMP sequence number with a gateway-generated sequence number, store a mapping between the original and replacement sequence numbers, replace the source IP address with the gateway component's local IP address, recalculate the ICMP checksum, and forward the modified packet to the remote target host; and upon receiving a corresponding ICMP Echo Reply from the remote target host, restore the original sequence number and source address using the stored mapping, and transmit the restored packet through the router component to the proxy component.

### Embodiment A.11

Further to embodiment A, where the proxy component and gateway component support IPv6 network projection by: the proxy component responding to Neighbor Discovery Protocol (NDP) Neighbor Solicitation messages for projected IPv6 addresses with Neighbor Advertisement messages containing the proxy component's link-layer address; handling Router Solicitation and Router Advertisement messages; and the translation module performing IPv6 address translation including handling of IPv6 extension headers.

### Embodiment A.12

Further to embodiment A, where further included is a multicast and broadcast forwarding module configured to: at the proxy component, capture multicast or broadcast packets on the first network and selectively forward them through the transport connection to the gateway component; and at the gateway component, inject the forwarded multicast or broadcast packets onto the second network; wherein the forwarding is selective based on at least one of: multicast group address, protocol type, or a configured filter policy, enabling service discovery protocols to operate across the network projection boundary.

### Embodiment A.13

Further to embodiment A, where the router component maintains connections to a plurality of gateway components each targeting the same remote target host, and further comprises: a health monitoring module configured to verify liveness of each gateway connection using at least one of transport-level heartbeat messages or absence-of-data timeout detection; and a failover module configured to, upon detecting failure of an active gateway connection, redirect traffic from the proxy component to an alternative gateway connection, thereby maintaining continuity of the network projection.

### Embodiment A.14

Further to embodiment A, where at least one of the proxy component or the gateway component executes within a container runtime environment including at least one of Docker, Podman, or containerd, and operates with Linux capabilities including NET_ADMIN and BPF to enable packet capture and injection without requiring full root privileges.

### Embodiment A.15

Further to embodiment A, where when the gateway component disconnects from the router component, the router component maintains the proxy component's transport connection in a pending state, and upon the gateway component reconnecting and re-establishing a transport connection with the same matching identifier, the router component re-links the proxy component's connection to the new gateway connection, and the proxy component resumes packet forwarding without requiring re-establishment of the proxy component's transport connection.

### Embodiment A.16

Further to embodiment A, where further included is an access control module at the router component configured to enforce connection policies specifying which proxy components are authorized to connect to which gateway components, and optionally specifying permitted protocol types, port ranges, or time-of-day restrictions, wherein unauthorized connection attempts are rejected at the router component before any packet data is forwarded.

### Embodiment A.17

Further to embodiment A, where further included is a configuration interface accessible via at least one of: a REST API, a GraphQL API, or a Machine Control Protocol (MCP) interface, the configuration interface enabling programmatic creation, modification, and deletion of proxy components, gateway components, and connection linking rules, wherein an AI agent or automation system can configure the network projection system through the configuration interface without human intervention.

### Embodiment B

A system, method and computer program product are provided for network IP projection. Included is:
a first computing device on a first network, the first computing device executing a proxy component configured to:
bind to a network interface of the first computing device to capture network packets using at least one of packet capture (pcap), extended Berkeley Packet Filter (eBPF), or raw sockets;
establish a transport connection to a router component over a communication channel;
maintain a network address translation (NAT) table storing mappings of source IP addresses, destination IP addresses, ports, and MAC addresses;
upon receiving a packet from a local host on the first network directed to a projected IP address, perform a lookup in the NAT table, and when a matching entry exists, clear locally identifying information from the packet, insert a mapping index into a port field, update a timestamp in the NAT table, and transmit the modified packet to the router component via the transport connection;
upon receiving a packet from a local host when no matching NAT table entry exists, create a new mapping entry storing the source IP address, source port, and source MAC address, assign an index, and transmit the modified packet to the router component; and
upon receiving a return packet from the router component via the transport connection, extract mapping data from the NAT table using a port-based index, insert source and destination IP addresses and ports into the packet, prepend an Ethernet header with appropriate MAC addresses, and inject the reconstructed packet onto the first network such that the local host perceives the packet as originating from a local entity on the first network.

### Embodiment B.1

Further to embodiment B, where further included is an expiration module configured to periodically check the NAT table for expired mappings and remove expired entries to reclaim resources.

### Embodiment B.2

Further to embodiment B, where the transport connection comprises a WebSocket connection over TLS on port 443.

### Embodiment B.3

Further to embodiment B, where the transport connection comprises at least one of: a TCP socket, a UDP socket, a QUIC connection, a WebSocket connection, or an MPLS label-switched path.

### Embodiment B.4

Further to embodiment B, where the proxy component executes within a container in a Docker network, a Kubernetes pod, or a virtual machine within a hyperscaler cloud environment.

### Embodiment B.5

Further to embodiment B, where the proxy component captures packets before a host TCP/IP stack processes them by operating on a network interface packet ring buffer using eBPF or XDP.

### Embodiment B.6

Further to embodiment B, where the proxy component further comprises a translator module configured to perform at least one of: one-to-one NAT, flow-based tracking using a 5-tuple of source IP, destination IP, source port, destination port, and protocol, deep packet inspection to extract application-layer metadata, or unique packet hash generation.

### Embodiment B.7

Further to embodiment B, where the proxy component further comprises a post-processing module configured to perform at least one of: encryption, decryption, cryptographic signature verification, packet integrity verification, packet logging, packet timestamping, or packet fragmentation and reassembly.

### Embodiment B.8

Further to embodiment B, where the proxy component or the gateway component operates on bare metal hardware and is configured to:
capture network packets destined for a bridge network CIDR range using XDP;
capture traffic to a local IP address only when the destination port falls within a designated port range;
inject outbound packets onto a network interface using pcap with the local IP address as the source IP; and
perform NAT using only the designated port range for return traffic identification.

### Embodiment C

A system, method and computer program product are provided for network IP projection. Included is:
a second computing device on a second network, the second computing device executing a gateway component configured to:
bind to a network interface of the second computing device to capture network packets using at least one of packet capture (pcap), extended Berkeley Packet Filter (eBPF), or raw sockets;
establish a transport connection to a router component over a communication channel;
maintain a mapping table storing dynamic port mappings, including source IP addresses, destination IP addresses, and ephemeral port allocations;
upon receiving a packet from the router component via the transport connection, extract a destination port, determine whether a source port mapping exists in the mapping table, and when no source port mapping exists, allocate an ephemeral port, create a mapping entry associating the ephemeral port with the source port, construct an Ethernet header and an IP header using the ephemeral port, a local IP address of the gateway component, and a target IP address of a target host, and inject the constructed packet onto the second network;
upon receiving a response packet from the target host on the second network destined for the ephemeral port, perform a lookup in the mapping table, clear the destination IP and port, insert a mapping index into a destination port field, update a timestamp, and transmit the modified packet to the router component via the transport connection.

### Embodiment C.1

Further to embodiment C, where further comprising an expiration module configured to periodically identify and remove expired mappings from the mapping table.

### Embodiment C.2

Further to embodiment C, where the gateway component targets at least one of: a standalone server, a server cluster, a localhost address, a load balancer, a public internet IP address, a private IP address in a virtual private cloud, an IP address in a containerized network, an IoT device, or a mobile device.

### Embodiment C.3

Further to embodiment C, where the gateway component executes in at least one of: a Docker container, a Kubernetes pod, a virtual machine, a cloud environment, a company network, a personal network, a cellular network, or on an IoT device.

### Embodiment C.4

Further to embodiment C, where the gateway component rewrites the source IP address of a packet to its own local IP address before forwarding the packet to the target host, such that the target host perceives the gateway component as the originator of the packet.

### Embodiment C.5

Further to embodiment C, where the gateway component rewrites the source IP address of a packet to a virtual IP address, and emulates or spoofs one or more virtual IP addresses to appear as sources of packets on the second network.

### Embodiment C.6

Further to embodiment C, where the gateway component further comprises an ICMP handling module configured to:
detect an ICMP Echo Request packet;
extract a sequence number from the ICMP Echo Request packet;
replace the sequence number with a gateway-generated sequence number and store a mapping between the original sequence number and the gateway-generated sequence number along with the source IP address;
replace the source IP address and forward the modified packet to the target host;
upon receiving an ICMP Echo Reply from the target host, extract the gateway-generated sequence number, look up the mapping, restore the original destination IP address and sequence number, and transmit the restored packet to the router component.

### Embodiment C.7

Further to embodiment C, where the proxy component or the gateway component operates on bare metal hardware and is configured to:
capture network packets destined for a bridge network CIDR range using XDP;
capture traffic to a local IP address only when the destination port falls within a designated port range;
inject outbound packets onto a network interface using pcap with the local IP address as the source IP; and
perform NAT using only the designated port range for return traffic identification.

### Embodiment D

A system, method and computer program product are provided for routing packets in a network IP projection architecture. Included is:
a router component executing on a computing device, the router component configured to:
establish a transport listener on a specified port to accept incoming transport connections;
upon receiving a new connection, parse a URI address from the connection request;
determine whether an existing connection is associated with the parsed URI address;
when an associated connection exists, link the new connection with the associated connection such that data frames received on one linked connection are copied and forwarded to the other linked connection;
when no associated connection exists, maintain the new connection in an unlinked state pending arrival of an associated connection;
upon detecting a termination event on a linked connection, unlink the connection while maintaining the peer connection in a connected state available for re-association with a subsequent connection sharing the same URI address.

### Embodiment D.1

Further to embodiment D, where the transport listener is a WebSocket listener operating on port 443 using TLS encryption.

### Embodiment D.2

Further to embodiment D, where the router component is accessible via at least one of: a public internet address, a private network, a load balancer, a reverse proxy, or a VPN.

### Embodiment D.3

Further to embodiment D, where a plurality of router components communicate with each other using direct peer-to-peer links, and wherein routing decisions between router components are based on at least one of: static routing tables, dynamically computed paths, packet classification metadata, security policies, geolocation, or network conditions including latency and congestion.

### Embodiment D.4

Further to embodiment D.3, where router-to-router connections are encrypted and authenticated using at least one of: IPsec, WireGuard, TLS, or QUIC-based VPN tunnels.

### Embodiment D.5

Further to embodiment D.3, where router-to-router connections utilize at least one of: the public internet, dark fiber, MPLS, segment routing, point-to-point wireless links, private IP links, or satellite links.

### Embodiment E

A system, method and computer program product are provided for projecting a network IP address from a first network to a second network. Included is:
a proxy component executing on a first computing device connected to the first network, the proxy component configured to capture packets from local hosts on the first network directed to a projected IP address, translate the captured packets by performing network address translation using a NAT table, strip locally identifying information, and transmit the translated packets over a transport connection;
a gateway component executing on a second computing device connected to the second network, the gateway component configured to receive translated packets over a transport connection, reconstruct the packets by inserting local addressing information using a mapping table with ephemeral port allocations, and inject the reconstructed packets onto the second network directed to a target host, such that the target host perceives the packets as originating from the gateway component or a virtual IP address; and
a router component configured to receive transport connections from the proxy component and the gateway component, link the connections based on a shared URI address, and forward data frames between the linked connections,
wherein the combined operation of the proxy component, the router component, and the gateway component projects the target host onto the first network such that local hosts on the first network communicate with the projected IP address as though the target host were a local entity on the first network.

### Embodiment E.1

Further to embodiment E, where the proxy component, the gateway component, and the router component each comprise a bidirectional processing stack including: a transport layer, a post-processing layer, a translator layer, a filter/capture layer, and a network interface layer, and wherein packets are processed through the stack in both an outbound direction and an inbound direction.

### Embodiment E.2

Further to embodiment E, where the proxy component and the gateway component each capture packets before a host TCP/IP stack processes them using at least one of: eBPF, XDP operating on a network interface packet ring buffer, PCAP, or a /dev/bpf0 interface.

### Embodiment E.3

Further to embodiment E, where the proxy component operates on the first network in a first geographic location and the gateway component operates on the second network in a second geographic location different from the first geographic location, and wherein the router component connects the proxy component and the gateway component across the geographic locations via the transport connections.

### Embodiment F

A system, method and computer program product are provided for projecting an IP address from a first network to a second network. Included is:
receiving, at a first host on the first network, a packet from a source host on the first network, the packet directed to a projected IP address;
identifying the packet based on at least one characteristic selected from the group consisting of: source IP address, destination IP address, source port, destination port, protocol, MAC address, and packet type;
translating the packet by performing network address translation, including storing a mapping of source addressing information in a NAT table and replacing locally identifying information with a mapping index;
routing the translated packet to a second host on the second network via a router component, the routing based on at least one of: a stored association, a shared key, a preconfigured route table, a dynamic route table, geolocation, network load, network latency, or management packets;
delivering the translated packet to the second host via a transport connection;
at the second host, reconstructing the packet by inserting local addressing information from a mapping table, including allocating an ephemeral port for source port mapping;
sending the reconstructed packet to a target host on the second network, the packet modified so that the target host perceives the packet as originating from the second host or a virtual IP address rather than the source host on the first network;
receiving a response packet from the target host at the second host;
translating the response packet by performing reverse network address translation using the mapping table;
routing the translated response packet back to the first host via the router component;
at the first host, reconstructing the response packet using the NAT table to restore addressing information; and
injecting the reconstructed response packet onto the first network such that the source host perceives the response as originating from the projected IP address on the first network.

### Embodiment F.1

Further to embodiment F, where further included is periodically checking the NAT table and the mapping table for expired entries and removing expired entries.

### Embodiment F.2

Further to embodiment F, where routing the translated packet to the second host comprises linking transport connections from the first host and the second host at the router component based on a matching URI address.

### Embodiment F.3

Further to embodiment F, where the transport connection comprises at least one of: a WebSocket connection, a TCP socket, a UDP socket, a QUIC connection, an MPLS label-switched path, a VXLAN encapsulation, a GRE tunnel, an IPsec tunnel, or an SSH tunnel.

### Embodiment F.4

Further to embodiment F, where further included is, at the first host, capturing the packet before a host TCP/IP stack processes the packet by intercepting the packet using at least one of: eBPF, XDP, PCAP, or a raw socket interface operating on a network interface packet ring buffer.

### Embodiment F.5

Further to embodiment F, where further included is, at the second host, emulating or spoofing a gateway or route to present a preferred path for one or more IP addresses on the second network.

### Embodiment F.6

Further to embodiment F, where a plurality of proxy components on a plurality of different networks each connect to the router component, and wherein each proxy component projects the same target host accessible through the gateway component, thereby enabling multiple disparate networks to simultaneously access the target host as though it were local to each respective network.

### Embodiment F.7

Further to embodiment F, where the proxy component and the gateway component may bypass the router component for some or all traffic by establishing a direct transport connection between the proxy component and the gateway component.

### Embodiment G

A system, method and computer program product are provided. Included is a non-transitory computer-readable medium storing instructions that, when executed by one or more processors, cause the one or more processors to:
execute a proxy process on a first computing device connected to a first network, the proxy process configured to bind to a network interface, capture packets directed to a projected IP address, perform network address translation using a NAT table, strip locally identifying information from captured packets, and transmit translated packets over a transport connection to a router process;
execute a router process on a computing device accessible over a communication network, the router process configured to accept transport connections, link connections sharing a common URI address, and forward data frames between linked connections; and
execute a gateway process on a second computing device connected to a second network, the gateway process configured to receive translated packets from the router process, reconstruct the packets using a mapping table with ephemeral port allocations, inject reconstructed packets onto the second network directed to a target host, receive response packets from the target host, translate the response packets using the mapping table, and transmit the translated response packets to the router process for delivery to the proxy process,
wherein the combined execution of the proxy process, the router process, and the gateway process causes the target host to appear as a local entity on the first network at the projected IP address.

### Embodiment G.1

Further to embodiment G, where the instructions further cause the one or more processors to deploy the proxy process as a container within a Docker network or Kubernetes cluster, the container configured with at least NET_ADMIN, SYS_RESOURCE, and BPF capabilities.

### Embodiment G.2

Further to embodiment G, where the instructions further cause the one or more processors to generate deployment configurations for the proxy process and the gateway process, the deployment configurations comprising at least one of: Docker run commands, Docker Compose YAML files, Kubernetes manifests, systemd service definitions, or shell scripts.

### Embodiment H

A system, method and computer program product are provided for configuring and managing network IP projection components. Included is:
a user interface configured to present a gateway configuration module, the gateway configuration module comprising: a network selector for selecting a target network, a gateway name input field, a gateway target input field for specifying a target hostname or IP address, and a tabbed control surface presenting at least one of a command tab displaying a container run command, a compose tab displaying a container orchestration configuration, and an environment tab displaying required environment variables;
a user interface configured to present a proxy configuration module, the proxy configuration module comprising: a network selector, a target gateway selector for selecting a gateway to be proxied, and a tabbed control surface presenting deployment configurations; and
a deployment generation module configured to generate execution commands and configuration files for deploying the gateway component and the proxy component across a plurality of runtime environments including at least one of: container runtimes, bare-metal execution contexts, virtual machine environments, or orchestration platforms.

### Embodiment H.1

Further to embodiment H, where further included is a network visualization interface configured to display a graphical representation of active gateway nodes, proxy nodes, and network nodes, wherein gateway nodes are visually distinguished from proxy nodes, and wherein the visualization displays geographic location metadata and connectivity relationships between nodes.

### Embodiment H.2

Further to embodiment H, where the configuration and management of the gateway component and the proxy component is accessible via at least one of: a REST API, a GraphQL API, or a Machine Control Protocol (MCP) interface.

### Embodiment I

A system, method and computer program product are provided for establishing an authenticated session between a proxy component and a gateway component in a network IP projection system. Included is:
at the proxy component, generating a bearer token and establishing a transport connection to a router component, wherein the router component authenticates the transport connection using the bearer token;
at the router component, creating a proxy endpoint based on a name and domain associated with the authenticated proxy component, and resolving a corresponding gateway endpoint, wherein when the gateway endpoint is not available the router component returns a failure indication and waits for the gateway component to connect;
at the router component, storing a gateway identifier associated with the resolved gateway endpoint, generating a nonce, and computing a first session key by multiplying the nonce with a public key of the proxy component;
at the router component, transmitting the first session key, a proxy identifier, and the nonce to the gateway component via a gateway endpoint message;
at the gateway component, receiving the first session key and the proxy identifier, storing the proxy component in an array of associated proxy connections, obtaining a proxy index within the array, computing a second session key by multiplying the nonce with a public key of the gateway component, and transmitting the second session key and the proxy index back to the router component;
at the router component, forwarding the second session key to the proxy component;
at the proxy component, receiving the second session key from the gateway component, enabling traffic forwarding using the session keys; and
thereafter, when the proxy component sends a packet, setting a source port field to an index value encoded as a uint16 identifier, clearing the source IP address, and encrypting the packet using the session key, wherein the router component forwards the packet from the proxy identifier to the gateway identifier, and the gateway component decrypts the packet, adds the proxy index to the source IP address, and delivers the packet to the target host.

### Embodiment I.1

Further to embodiment I, where the bearer token is generated using a cryptographic function and is unique per proxy session.

### Embodiment I.2

Further to embodiment I, where the transport connection between the proxy component and the router component is a WebSocket connection over TLS, and the bearer token is transmitted as part of a WebSocket handshake or initial message.

### Embodiment I.3

Further to embodiment I, where the router component resolves the gateway endpoint by querying an API service that maintains a registry of gateway endpoints, and the API service performs an endpoint search to locate the gateway endpoint matching the proxy's requested name and domain.

### Embodiment I.4

Further to embodiment I, where the first session key and the second session key are derived using an elliptic-curve Diffie-Hellman key exchange, wherein the nonce serves as a shared ephemeral value, the public key of the proxy component and the public key of the gateway component are static or semi-static keys, and the resulting session keys provide forward secrecy for the encrypted packet stream.

### Embodiment I.5

Further to embodiment I, where the proxy index is an integer value representing the proxy component's position within the gateway component's array of connected proxy components, and the gateway component uses the proxy index to demultiplex incoming packets from multiple proxy components sharing the same gateway endpoint.

### Embodiment I.6

Further to embodiment I.5, where the gateway component adds the proxy index to a source IP address field of a received packet to create a unique per-proxy source IP address visible to the target host, enabling the target host to distinguish between traffic originating from different proxy components.

### Embodiment I.7

Further to embodiment I, where when the gateway component disconnects and subsequently reconnects to the router component, the router component re-establishes the session by performing a new nonce generation and key exchange, and the proxy component continues forwarding packets after receiving the new second session key, thereby providing session continuity across gateway restarts.

### Embodiment J

A system, method and computer program product are provided for authenticated packet routing in a network IP projection architecture. Included is:
a router component comprising: a transport listener configured to accept incoming connections; an authentication module configured to validate bearer tokens presented by connecting proxy components and gateway components; an endpoint registry configured to store and resolve proxy endpoints and gateway endpoints based on name and domain identifiers; a key exchange module configured to generate a nonce for each proxy-gateway session, compute a first session key using the nonce and a proxy public key, compute a second session key using the nonce and a gateway public key, and distribute the session keys to the respective components; and a forwarding module configured to forward encrypted packets between linked proxy endpoints and gateway endpoints based on stored identifiers;
wherein the router component does not possess the private keys of either the proxy component or the gateway component, and the session keys enable end-to-end encryption of packet data between the proxy component and the gateway component such that the router component forwards encrypted data without the ability to decrypt the packet contents.

### Embodiment J.1

Further to embodiment J, where the endpoint registry is backed by a persistent API service, and the router component queries the API service to resolve gateway endpoints, and the API service returns a failure indication when a requested gateway endpoint has not yet registered, causing the router component to hold the proxy connection in a pending state until the gateway component connects and registers its endpoint.

### Embodiment K

A system, method and computer program product are provided for projecting a remote IP address onto a local network. Included is:
a proxy component executing on a computing device connected to a local network, the proxy component configured to:
monitor a network interface for Address Resolution Protocol (ARP) Request packets whose Target Protocol Address matches a projected IP address corresponding to a remote target host on a remote network;
upon detecting an ARP Request for the projected IP address, generate an ARP Reply packet containing the proxy component's own MAC address as the Sender Hardware Address and the projected IP address as the Sender Protocol Address, and transmit the ARP Reply onto the local network, thereby causing the requesting host to direct subsequent packets for the projected IP address to the proxy component's network interface;
capture packets received at the network interface that are destined for the projected IP address;
translate the captured packets by performing network address translation and transmit the translated packets to a router component for delivery to a gateway component on the remote network; and
receive return packets from the router component, reconstruct the return packets with the projected IP address as the source address, and inject the reconstructed packets onto the local network,
wherein local hosts on the local network communicate with the projected IP address as though the remote target host were physically present on the local network, without any software installation, configuration change, or routing modification on the local hosts.

### Embodiment K.1

Further to embodiment K, where the proxy component further broadcasts a Gratuitous ARP announcement upon startup, the Gratuitous ARP containing the projected IP address and the proxy component's MAC address, thereby pre-populating ARP caches of local hosts on the local network.

### Embodiment K.2

Further to embodiment K, where the proxy component simultaneously projects a plurality of IP addresses, each corresponding to a different remote target host, and responds to ARP requests for each projected IP address with the proxy component's own MAC address.

### Embodiment K.3

Further to embodiment K, where the proxy component detects ARP conflict conditions when another device on the local network broadcasts an ARP announcement claiming the projected IP address, and in response, the proxy component reasserts ownership by broadcasting a Gratuitous ARP with the proxy component's MAC address.

### Embodiment K.4

Further to embodiment K, where the proxy component maintains an ARP tracking table recording which local hosts have resolved the projected IP address, and uses the ARP tracking table to implement host-level access control by selectively responding to ARP requests from authorized hosts and ignoring ARP requests from unauthorized hosts.

### Embodiment L

A system, method and computer program product are provided for transparently projecting a remote host onto a local Ethernet network. Included is:
configuring a proxy component on the local network with a projected IP address corresponding to a remote target host;
broadcasting, by the proxy component, a Gratuitous ARP announcement associating the projected IP address with a MAC address of the proxy component;
receiving, at the proxy component, an ARP Request from a local host on the local network requesting the hardware address for the projected IP address;
transmitting, by the proxy component, an ARP Reply containing the proxy component's MAC address as the hardware address for the projected IP address;
receiving, at the proxy component, IP packets from the local host addressed to the projected IP address, the IP packets directed to the proxy component's MAC address as a result of the ARP Reply;
translating the received IP packets by stripping locally identifying information and transmitting the translated packets through a transport connection to a gateway component on a remote network;
at the gateway component, reconstructing the packets and delivering them to the remote target host; and
receiving response packets from the remote target host via the gateway component, reconstructing the response packets with the projected IP address as the source, and injecting the response packets onto the local network,
wherein the local host's ARP cache associates the projected IP address with the proxy component's MAC address, and the local host's operating system and applications perceive the remote target host as a local network entity requiring no special configuration.

### CONCLUSION

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that several of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A system for network IP projection, comprising:
a proxy component executing on a first computing device connected to a first network, the proxy component comprising:
a capture module configured to intercept packets on a network interface of the first computing device before the packets reach a host TCP/IP stack, the intercepted packets being addressed to a projected IP address associated with a remote target host on a second network;
a network address translation (NAT) table configured to store mappings between local connection attributes on the first network and corresponding translated connection attributes;
a translation module configured to translate the intercepted packets by replacing at least a source IP address and a source port with translated values from the NAT table and setting a mapping index in the translated packet; and
a transport interface configured to transmit the translated packets over a transport connection to a router component;
the router component executing on a second computing device, the router component comprising:
a transport listener configured to accept incoming transport connections from proxy components and gateway components;
a connection linking module configured to associate a transport connection from the proxy component with a transport connection from a gateway component based on a matching identifier, forming a bidirectional data path; and
a forwarding module configured to forward data received on one linked transport connection to the other linked transport connection;
a gateway component executing on a third computing device connected to the second network, the gateway component comprising:
a receiving module configured to receive translated packets from the router component via a transport connection;
an ephemeral port allocation module configured to allocate ephemeral ports on the second network for received translated packets;
a reconstruction module configured to reconstruct received translated packets by replacing the translated values with the gateway component's local IP address as a source address and the allocated ephemeral port as a source port, and setting the destination address to the IP address of the remote target host; and
an injection module configured to inject the reconstructed packets onto the second network for delivery to the remote target host;
wherein the combination of the proxy component, the router component, and the gateway component causes the projected IP address to appear on the first network as a local network entity, such that hosts on the first network communicate with the projected IP address without any software installation, configuration change, or routing modification on the hosts, and the remote target host receives packets as though they originated from a local host on the second network.

2. The system of claim 1, wherein the proxy component further comprises an ARP response module configured to: monitor the network interface for Address Resolution Protocol (ARP) Request packets whose Target Protocol Address matches the projected IP address; and upon detecting such an ARP Request, generate and transmit an ARP Reply containing the proxy component's own MAC address as the Sender Hardware Address and the projected IP address as the Sender Protocol Address, thereby causing hosts on the first network to direct packets for the projected IP address to the proxy component's network interface.

3. The system of claim 2, wherein the proxy component further broadcasts a Gratuitous ARP announcement upon startup or upon configuration change, the Gratuitous ARP containing the projected IP address and the proxy component's MAC address as both the Sender and Target Protocol Addresses, thereby pre-populating ARP caches of hosts on the first network.

4. The system of claim 1, further comprising an authentication and key exchange protocol wherein:
the proxy component generates a bearer token and authenticates a transport connection to the router component using the bearer token;
the router component creates a proxy endpoint based on a name and domain associated with the authenticated proxy component, resolves a corresponding gateway endpoint, stores a gateway identifier, generates a nonce, and computes a first session key by combining the nonce with a public key of the proxy component;
the router component transmits the first session key, a proxy identifier, and the nonce to the gateway component;
the gateway component stores the proxy component in an array of associated proxy connections, obtains a proxy index within the array, computes a second session key by combining the nonce with a public key of the gateway component, and transmits the second session key and the proxy index to the router component;
the router component forwards the second session key to the proxy component; and
thereafter, the proxy component and the gateway component encrypt packet data using the respective session keys, such that the router component forwards encrypted packet data without the ability to decrypt the packet contents.

5. The system of claim 4, wherein the proxy index is an integer value representing the proxy component's position within the gateway component's array of connected proxy components, and the gateway component uses the proxy index to demultiplex incoming packets from multiple proxy components sharing the same gateway endpoint, and adds the proxy index to a source IP address field to create a unique per-proxy source IP address visible to the remote target host.

6. The system of claim 1, wherein the capture module intercepts packets using at least one of: extended Berkeley Packet Filter (eBPF) programs loaded into the kernel to process packets before the host TCP/IP stack, eXpress Data Path (XDP) programs executing at the network interface driver level, packet capture (pcap) library, or the /dev/bpf interface.

7. The system of claim 1, wherein each entry in the NAT table includes a timestamp indicating a last-used time, and the proxy component periodically removes entries whose last-used time exceeds a configurable expiration threshold.

8. The system of claim 7, wherein the NAT table further comprises connection state tracking entries that track TCP connection states including at least SYN_SENT, ESTABLISHED, and CLOSED, and the proxy component uses the tracked connection state to determine appropriate timeout values for NAT table entries, such that entries in ESTABLISHED state have a longer expiration threshold than entries in other states.

9. The system of claim 1, wherein the transport connection between the proxy component and the router component, and between the router component and the gateway component, uses at least one of: WebSocket over TLS, QUIC, TCP, or UDP.

10. The system of claim 1, wherein the matching identifier used by the connection linking module comprises at least one of: a URI path component, a shared cryptographic key, a bearer token, a certificate common name, a pre-configured route identifier, or a network name, and the connection linking module maintains the association such that data received on one linked connection is forwarded to the other.

11. The system of claim 1, wherein the gateway component further comprises an ICMP handling module configured to: upon receiving an ICMP Echo Request packet from the router component, replace the ICMP sequence number with a gateway-generated sequence number, store a mapping between the original and replacement sequence numbers, replace the source IP address with the gateway component's local IP address, recalculate the ICMP checksum, and forward the modified packet to the remote target host; and upon receiving a corresponding ICMP Echo Reply from the remote target host, restore the original sequence number and source address using the stored mapping, and transmit the restored packet through the router component to the proxy component.

12. The system of claim 1, wherein the proxy component and gateway component support IPv6 network projection by: the proxy component responding to Neighbor Discovery Protocol (NDP) Neighbor Solicitation messages for projected IPV6 addresses with Neighbor Advertisement messages containing the proxy component's link-layer address; handling Router Solicitation and Router Advertisement messages; and the translation module performing IPV6 address translation including handling of IPV6 extension headers.

13. The system of claim 1, further comprising a multicast and broadcast forwarding module configured to: at the proxy component, capture multicast or broadcast packets on the first network and selectively forward them through the transport connection to the gateway component; and at the gateway component, inject the forwarded multicast or broadcast packets onto the second network; wherein the forwarding is selective based on at least one of: multicast group address, protocol type, or a configured filter policy, enabling service discovery protocols to operate across the network projection boundary.

14. The system of claim 1, wherein the router component maintains connections to a plurality of gateway components each targeting the same remote target host, and further comprises: a health monitoring module configured to verify liveness of each gateway connection using at least one of transport-level heartbeat messages or absence-of-data timeout detection; and a failover module configured to, upon detecting failure of an active gateway connection, redirect traffic from the proxy component to an alternative gateway connection, thereby maintaining continuity of the network projection.

15. The system of claim 1, wherein at least one of the proxy component or the gateway component executes within a container runtime environment including at least one of Docker, Podman, or containerd, and operates with Linux capabilities including NET_ADMIN and BPF to enable packet capture and injection without requiring full root privileges.

16. The system of claim 1, wherein when the gateway component disconnects from the router component, the router component maintains the proxy component's transport connection in a pending state, and upon the gateway component reconnecting and re-establishing a transport connection with the same matching identifier, the router component re-links the proxy component's connection to the new gateway connection, and the proxy component resumes packet forwarding without requiring re-establishment of the proxy component's transport connection.

17. The system of claim 1, further comprising an access control module at the router component configured to enforce connection policies specifying which proxy components are authorized to connect to which gateway components, and optionally specifying permitted protocol types, port ranges, or time-of-day restrictions, wherein unauthorized connection attempts are rejected at the router component before any packet data is forwarded.

18. The system of claim 1, further comprising a configuration interface accessible via at least one of: a REST API, a GraphQL API, or a Machine Control Protocol (MCP) interface, the configuration interface enabling programmatic creation, modification, and deletion of proxy components, gateway components, and connection linking rules, wherein an AI agent or automation system can configure the network projection system through the configuration interface without human intervention.

19. A method for projecting a remote host onto a local network, comprising:
at a proxy component on a first network, monitoring a network interface for ARP Request packets whose Target Protocol Address matches a projected IP address, and responding with an ARP Reply containing the proxy component's MAC address;
at the proxy component, intercepting IP packets addressed to the projected IP address before the packets reach a host TCP/IP stack;
translating the intercepted packets by performing network address translation using a NAT table, replacing at least a source IP address and a source port with translated values;
transmitting the translated packets over a transport connection to a router component;
at the router component, linking the transport connection from the proxy component with a transport connection from a gateway component based on a matching identifier, and forwarding the translated packets to the gateway component;
at the gateway component on a second network, allocating an ephemeral port, reconstructing the translated packets with the gateway component's local IP address and the ephemeral port as source attributes and the remote target host's IP address as the destination, and injecting the reconstructed packets onto the second network;
receiving response packets from the remote target host at the gateway component, translating the response packets, forwarding them through the router component to the proxy component, and injecting the response packets onto the first network with the projected IP address as the source;
wherein hosts on the first network communicate with the projected IP address as a local network entity without any software installation, configuration change, or routing modification on the hosts.

20. A computer program product for network IP projection, the computer program product comprising one or more computer-readable storage media collectively having program instructions embodied therewith, the program instructions executable by one or more processors to cause the one or more processors to:
execute a proxy component on a first computing device connected to a first network, the proxy component configured to respond to ARP Requests for a projected IP address with ARP Replies containing the first computing device's MAC address, intercept IP packets addressed to the projected IP address before a host TCP/IP stack, perform network address translation using a NAT table, and transmit translated packets over a transport connection;
execute a router component on a second computing device, the router component configured to accept transport connections, link a transport connection from the proxy component with a transport connection from a gateway component based on a matching identifier, and forward data between the linked connections;
execute the gateway component on a third computing device connected to a second network, the gateway component configured to receive translated packets, allocate ephemeral ports, reconstruct the translated packets with local addressing, and inject the reconstructed packets onto the second network for delivery to a remote target host;
wherein the program instructions cause the projected IP address to appear on the first network as a local network entity, such that hosts on the first network communicate with the projected IP address without modification, and the remote target host receives packets as though they originated locally on the second network.
